(19) United States
(12) Patent Application Publication
(10) Pub. No.: US 2026/0267060 A1
(43) Pub. Date: Sep. 10, 2026

(54) OPTICAL-SWITCH-ENABLED RECONFIGURABLE PHOTONIC INTERPOSERS FOR 2.5D/3D CHIPLET INTEGRATED SYSTEMS

(71) Applicant: Colorado State University Research Foundation, Fort Collins, CO (US)

(72) Inventors: Mahdi NIKDAST, Fort Collins, CO (US); Mohammad Amin MAHDIAN, Fort Collins, CO (US); Ebadollah TAHERI, Fort Collins, CO (US)

(21) Appl. No.: 19/558,331

(22) Filed: Mar. 5, 2026

Related U.S. Application Data
(60) Provisional application No. 63/767,260, filed on Mar. 5, 2025.

(51) Int. Cl. G02B 6/12

(52) U.S. Cl. CPC G02B 6/12002; G02B 2006/12145

(57) ABSTRACT

A wafer-scale photonic chiplet-based system comprising an interposer including a plurality of waveguides, a plurality of chiplets coupled to the interposer, each chiplet having a port coupled to a waveguide, an optical circuit switch coupled to the plurality of waveguides and configured to selectively establish circuit-switched optical connections between chiplets via the plurality of waveguides, and control circuitry configured to program the optical circuit switch to set a connectivity configuration that persists until reprogrammed. The disclosure includes systems, methods, and device designs encoded on non-transitory computer-readable media. This abstract is a required formal section and is not intended to limit the scope of the appended claims.

### CROSS-REFERENCE TO RELATED APPLICATIONS

This application claims the benefit of priority under 35 U.S.C. § 119(e) to U.S. Provisional Application No. 63/767,260, filed Mar. 5, 2025, the entire contents of which are incorporated herein by reference.

### STATEMENT OF GOVERNMENT RIGHTS

This invention was made with government support under grant 2046226 awarded by the National Science Foundation. The government has certain rights in the invention.

### SUMMARY

The following summary is provided as a prelude to the Detailed Description that follows. The scope of the disclosed technology is defined by the appended claims, and the following summary and all other descriptions and examples herein are nonlimiting.

The present disclosure includes embodiments of a photonic chiplet-based interposer system, a method of operating such a system, and a device design encoded on a non-transitory computer-readable medium.

In one aspect, the disclosure includes a system comprising: an interposer including a plurality of waveguides; a plurality of chiplets coupled to the interposer, each chiplet having at least one port coupled to a respective waveguide of the plurality of waveguides; an optical circuit switch coupled to the plurality of waveguides and configured to selectively establish circuit-switched optical connections between chiplets of the plurality of chiplets through the plurality of waveguides; and control circuitry configured to program the optical circuit switch to set a connectivity configuration that persists until reprogrammed.

In some embodiments, the control circuitry maintains precomputed switch configurations for a plurality of connectivity patterns and, responsive to a circuit-configuration command, retrieves and applies one of the precomputed switch configurations to program the optical circuit switch.

In some embodiments, the optical circuit switch implements connections among the plurality of waveguides using a switching network topology selected from: butterfly, crossbar, Clos, Benes, and PILOSS topologies.

In some embodiments, the interposer is an active silicon photonic interposer, and the optical circuit switch comprises a plurality of Mach-Zehnder interferometer (MZI) switch cells, each MZI switch cell comprising a first coupler, a second coupler, a first arm coupled between the first coupler and the second coupler, and a second arm coupled between the first coupler and the second coupler. In some embodiments, the plurality of chiplets includes at least one memory chiplet, such as a high-bandwidth memory (HBM) chiplet, and at least one multiply-accumulate (MAC) chiplet. In some embodiments, the control circuitry assigns a chiplet of the plurality of chiplets to an input port of the optical circuit switch, determines whether a requested circuit-switched optical connection would result in a blocking condition, and in response swaps the input-port assignment of a chiplet to a different input port of the optical circuit switch to resolve the blocking condition. In some embodiments, the control circuitry programs a first set of 2×2 optical switching elements, such as Mach-Zehnder interferometer switch cells or microring resonator switch cells, in a cross state or a bar state to establish one-to-one circuit-switched optical connections and programs a second set of switch cells, in a divide state to establish one-to-many circuit-switched optical connections.

In some embodiments, the interposer is a passive photonic interposer, the optical circuit switch is a switch chiplet, and the plurality of chiplets are each coupled to the passive photonic interposer via a plurality of optical vertical links (OVLs). In some embodiments, the system further comprises bandwidth allocation circuitry configured to determine a traffic demand for each of a plurality of pairs of chiplets and to iteratively allocate circuit-switched optical connections to chiplet pairs in order of decreasing traffic demand assigning additional circuit-switched optical connections to each pair until a connection threshold for that pair is satisfied. In some embodiments, each chiplet of the plurality of chiplets includes a plurality of OVL interfaces, optical transceiver circuitry, and an on-chiplet reconfigurable optical switch configured to selectively couple the optical transceiver circuitry to a subset of the plurality of OVL interfaces, wherein the number of OVL interfaces may be greater than, equal to, or, in wavelength-division multiplexed configurations, fewer than the number of active optical channels provided by the optical transceiver circuitry. In some embodiments, on-chiplet circuitry is configured to measure optical loss through each of the plurality of OVL interfaces and to configure the on-chiplet reconfigurable optical switch to couple the optical transceiver circuitry to a subset of OVL interfaces satisfying an optical loss condition. In some embodiments, the on-chiplet reconfigurable optical switch is further configured to in response to a control signal, expand the subset to include additional optical vertical link interfaces beyond those currently coupled to the optical transceiver circuitry.

In another aspect, the disclosure includes a method comprising: programming, by control circuitry, an optical circuit switch coupled to a plurality of waveguides of an interposer to set a connectivity configuration that persists until reprogrammed; and establishing, through the plurality of waveguides, one or more circuit-switched optical connections between chiplets of a plurality of chiplets coupled to the interposer. In some embodiments, the method further comprises, responsive to a circuit-configuration command, retrieving a precomputed switch configuration and applying it to program the optical circuit switch. In some embodiments, the method comprises programming a first set of MZI switch cells in a cross state or a bar state and programming a second set of MZI switch cells in a divide state. In some embodiments, the method comprises determining a traffic demand for each of a plurality of pairs of chiplets and iteratively allocating circuit-switched optical connections to chiplet pairs in order of decreasing traffic demand. In some embodiments, the method comprises measuring, by on-chiplet circuitry, optical loss through each of a plurality of OVL interfaces and configuring an on-chiplet reconfigurable optical switch to couple optical transceiver circuitry to a subset of OVL interfaces satisfying an optical loss condition.

In another aspect, the disclosure includes a non-transitory computer-readable medium storing a device design that encodes a photonic chiplet system comprising an interposer including a plurality of waveguides, a plurality of chiplets each having at least one port coupled to a respective waveguide, an optical circuit switch coupled to the plurality of waveguides, and control circuitry. In some embodiments, the device design encodes an active silicon photonic interposer comprising a plurality of MZI switch cells. In some embodiments, the device design encodes a passive photonic interposer, a switch chiplet, a plurality of OVL interfaces, optical transceiver circuitry, and an on-chiplet reconfigurable optical switch.

These and other features, aspects, and advantages of the embodiments described herein will become better understood with reference to the following description, appended claims, and accompanying drawings, wherein:

### BRIEF DESCRIPTION OF THE DRAWINGS

FIG. 1 is a schematic diagram of an embodiment of a photonic chiplet system including an interposer, a plurality of chiplets, an optical circuit switch, and control circuitry.

FIG. 2 is a schematic diagram of an embodiment of a chiplet system architecture including an active silicon photonic interposer.

FIG. 3 is a schematic diagram of an embodiment of a chiplet system including a passive photonic interposer and a switch chiplet connected to the passive photonic interposer via optical vertical links.

FIGS. 4A and 4B are schematic diagrams of a memory-to-MAC optical network and a MAC-to-memory optical network, respectively, of the system of FIG. 2.

FIGS. 5A through 5F are schematic diagrams showing first through fifth routing configurations and a broadcast routing configuration, respectively, of the optical circuit switch of FIGS. 4A-4B, showing example routing configurations for the memory-to-MAC and MAC-to-memory networks

FIGS. 6A through 6D are schematic diagrams of an embodiment of an MZI switch cell and an embodiment of an adiabatic microring resonator, respectively, of the system of FIG. 2.

FIGS. 7A and 7B are schematic diagrams of the system of FIG. 3 in a wavelength-selective switch configuration in which chiplets are addressed based on different wavelengths and a broadband N×N optical switch configuration in which multiple wavelengths are switched together, respectively.

FIGS. 8A through 8D are schematic diagrams illustrating optical vertical link redundancy, misalignment handling, and first and second on-chiplet reconfigurable optical switch configurations for optical vertical link subset selection in the system of FIG. 3.

FIGS. 9A through 9G are diagrams illustrating Algorithms 1 through 7, respectively, for input-port assignment, output-port assignment, unicast and broadcast network management, loss-aware routing, perfect-shuffle interconnection, in-situ OVL characterization and subset selection, and greedy bandwidth allocation.

FIG. 10 is a flowchart of an embodiment of a method of operating a photonic chiplet system.

FIG. 11 is a flowchart of a method of operating a photonic chiplet system in which the interposer is an active silicon photonic interposer.

FIG. 12 is a flowchart of a method of operating a photonic chiplet system in which the interposer is a passive photonic interposer.

FIG. 13 is a schematic diagram of an embodiment of a non-transitory computer-readable medium storing a device design encoding a photonic chiplet system.

In some embodiments, the interposer may be an active silicon photonic interposer integrating the optical circuit switch monolithically on the interposer substrate. In other embodiments, the interposer may be a passive photonic interposer and the optical circuit switch may be a separate switch chiplet coupled to the passive interposer via optical vertical links. In some embodiments, both configurations may implement the same broad platform concept and may share the same fundamental advantages of high bandwidth, low latency, and energy-efficient optical communication among chiplets. In some embodiments, the technology may further be implemented in a 5.5D integration configuration in which three-dimensional photonic chiplets, comprising stacked photonic integrated circuit layers, are coupled vertically above the passive photonic interposer via optical vertical links, adding a vertical dimension to a conventional 2.5D side-by-side chiplet arrangement.

The following description is presented to enable any person skilled in the art to make and use the described technology. Specific details are set forth to provide a thorough understanding of the present technology. It will be apparent to one skilled in the art that these specific details are not required to practice the described technology. Descriptions of specific embodiments and applications are provided only as examples. Various modifications to the disclosed embodiments will be readily apparent to those skilled in the art, and the general principles defined herein may be applied to other embodiments and applications without departing from the spirit and scope of the disclosure. The present disclosure is not intended to be limited to the embodiments shown, but is to be accorded the widest scope consistent with the principles and features disclosed herein. The scope of the described technology is defined by the appended claims, and all descriptions, examples, embodiments, and other disclosures herein are nonlimiting illustrations thereof.

Reference is made to particular features (including method steps) of embodiments of the disclosure. The disclosure includes all possible combinations of such particular features. For example, where a particular feature is disclosed in the context of a particular embodiment, that feature can also be used, to the extent possible, in combination with and in the context of other embodiments.

The term “comprises” and grammatical equivalents thereof are used herein to mean that other components, ingredients, steps, and the like are optionally present. For example, a system “comprising” A, B, and C can contain only A, B, and C, or can contain other elements in addition to A, B, and C.

Where reference is made to a method comprising two or more defined steps, the defined steps can be carried out in any order or simultaneously, except where the context excludes that possibility, and the method can include one or more other steps carried out before any of the defined steps, between two of the defined steps, or after all of the defined steps.

The term “at least” followed by a number denotes the start of a range beginning with that number. The term “at most” followed by a number denotes the end of a range ending with that number. As used herein, “approximately” and “about” mean within ten percent of a stated value unless the context indicates otherwise.

Although certain embodiments may be illustrated as planar circuits or interposer configurations, the disclosed technology is not limited to such configurations. In some embodiments, the technology may be implemented in three-dimensional chiplet stacking arrangements (including electronics, optoelectronics, and photonics), hybrid integration schemes, multilayer architectures, or any other configuration achieving the described optical interconnection functionality (including 5.5D integration in which 3D chiplets are stacked vertically above a passive photonic interposer via optical vertical links, adding a vertical dimension to a 2.5D side-by-side chiplet arrangement).

In some embodiments in which the interposer is a passive photonic interposer, the chiplets and the interposer are assembled according to one of a plurality of packaging configurations. Packaging configurations suitable for the passive interposer embodiment include, but are not limited to: a heterogeneous stack configuration in which a thin silicon photonic input/output die is bonded atop an electronic die, with electrical-to-optical and optical-to-electrical conversions occurring in the bonded silicon photonic layer; a side-by-side photonic input/output chiplet configuration in which a silicon photonic input/output chiplet is disposed adjacent to the electronic die and connected thereto via micro-bumps or hybrid bonds, with conversions occurring on the silicon photonic chiplet rather than on the interposer; and a monolithic electro-photonic chiplet configuration in which transmitter and receiver circuitry is co-fabricated with logic on a single die. In each of these configurations, the interposer remains passive and all active photonic components reside at the chiplet endpoints.

The described technology includes embodiments of a photonic chiplet system in which an interposer having a plurality of waveguides physically and optically connects a plurality of chiplets via optical ports to an optical circuit switch, with control circuitry programming the switch to establish circuit-switched optical connections that persist until reprogrammed. In some embodiments, the interposer is an active silicon photonic interposer integrating the optical circuit switch monolithically on the interposer substrate. In other embodiments, the interposer is a passive photonic interposer and the optical circuit switch is a separate switch chiplet coupled to the passive interposer via optical vertical links. Both embodiments implement the same broad platform concept and share the same fundamental advantages of high bandwidth, low latency, chiplet-to-chiplet reconfigurability, and energy-efficient optical communication among chiplets.

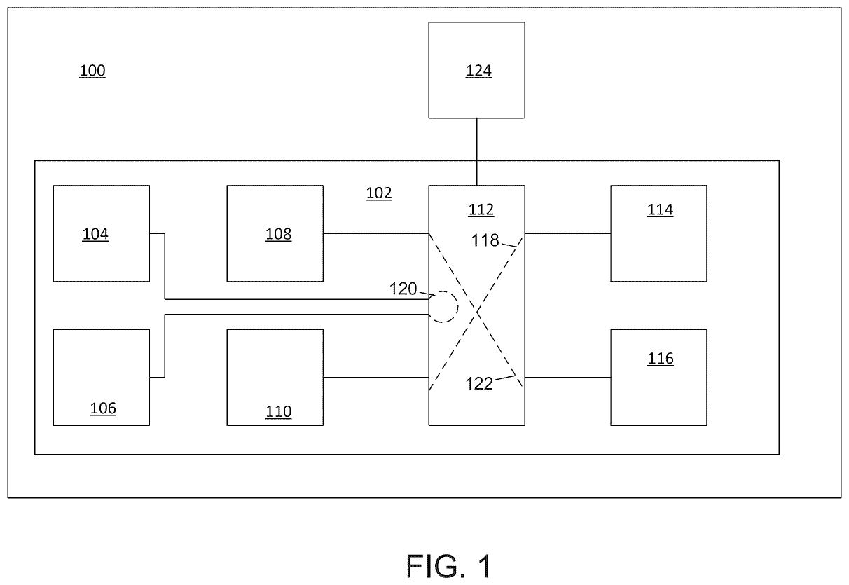

Referring to FIG. 1, an embodiment of a photonic chiplet system 100 is shown. In some embodiments, the system 100 may comprise an interposer 102, a plurality of chiplets 104, 106, 108, 110, 114, 116, an optical circuit switch 112, and control circuitry 124. The described technology may be implemented in any suitable architectural manner. For instance, in some embodiments, the optical circuit switch 112 and the control circuitry 124 may each be implemented as discrete chiplets integrated on or coupled to the interposer 102, rather than as components fabricated monolithically on the interposer substrate. The system 100 may include any number of chiplets, and the six chiplets shown are provided by way of example only.

In some embodiments, the interposer 102 may physically and optically connect the plurality of chiplets via a plurality of waveguides. The interposer 102 may take a variety of forms. In some embodiments, the interposer 102 is an active silicon photonic interposer in which active photonic switching components, including the optical circuit switch 112, may be integrated directly on the interposer substrate. In other embodiments, the interposer 102 is a passive photonic interposer in which the waveguides may be passive optical routing elements and active components, including the optical circuit switch 112, may reside in separate chiplets coupled to the interposer.

Each chiplet of the plurality of chiplets 104, 106, 108, 110 may be, for example, a discrete integrated circuit or photonic die coupled to the interposer 102 and configured to communicate with other chiplets through the waveguides and the optical circuit switch 112. Chiplets suitable for use in the system 100 include, but are not limited to, processing chiplets such as multiply-accumulate accelerators, memory chiplets, optical transceiver chiplets, switch chiplets, and laser chiplets, among others. In some implementations, each chiplet may have at least one port coupled to a respective waveguide of the interposer 102. In some implementations, the port may serve as an interface through which the chiplet sends and receives optical signals to and from the interposer. As used herein, a port coupled to a waveguide of the interposer may be an optical port or an optoelectronic port. An optical port provides a direct optical coupling between the chiplet and the interposer waveguide, such that an optical signal passes between the chiplet and the waveguide without intermediate conversion to the electrical domain. Technologies suitable for implementing optical ports include, but are not limited to, edge-coupling facets, grating couplers, and vertical optical coupling structures such as optical vertical links. An optoelectronic port provides an indirect coupling between the chiplet and the interposer waveguide in which an optical signal on the chiplet is converted to an electrical signal, the electrical signal is transferred through an electrical connector between the chiplet and the interposer, and the electrical signal is converted back to an optical signal on the interposer for propagation through the interposer waveguide, or vice versa. Technologies suitable for implementing optoelectronic ports include, but are not limited to, photodetector-to-modulator links in which a chiplet-side photodetector converts an optical signal to an electrical signal that is carried through solder bumps, micro-bumps, or hybrid bonds to an interposer-side modulator that re-encodes the electrical signal onto an optical carrier propagating in the interposer waveguide.

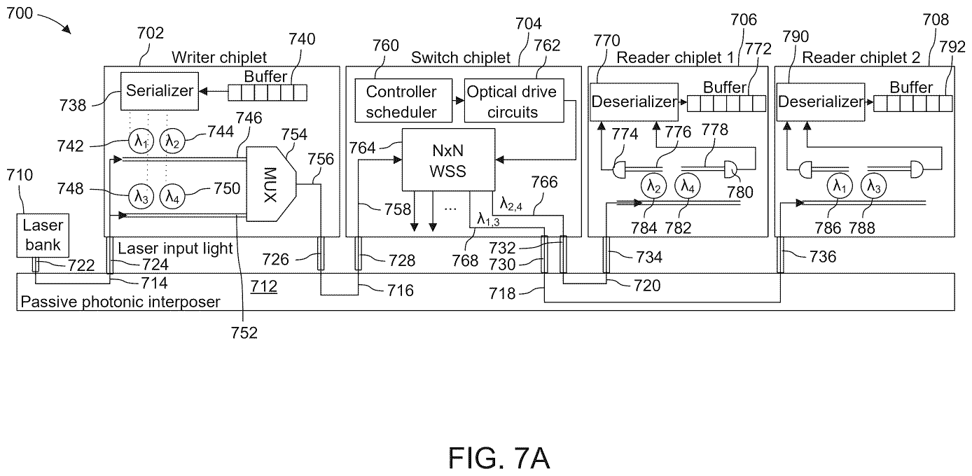

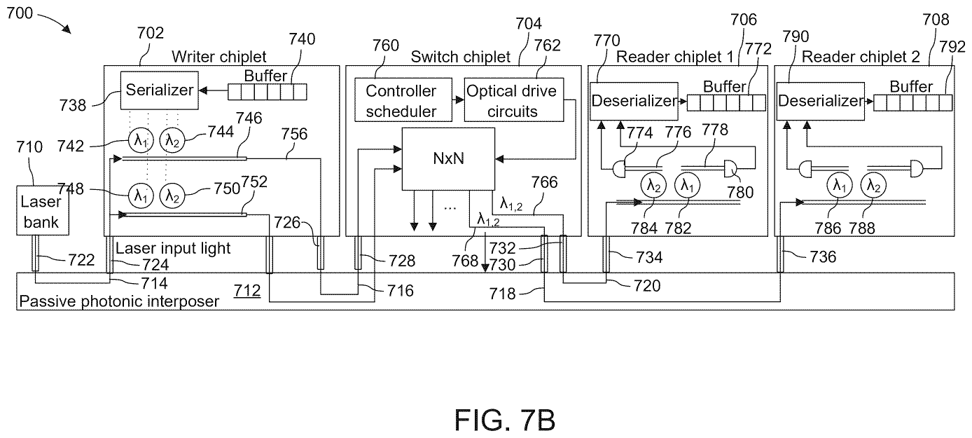

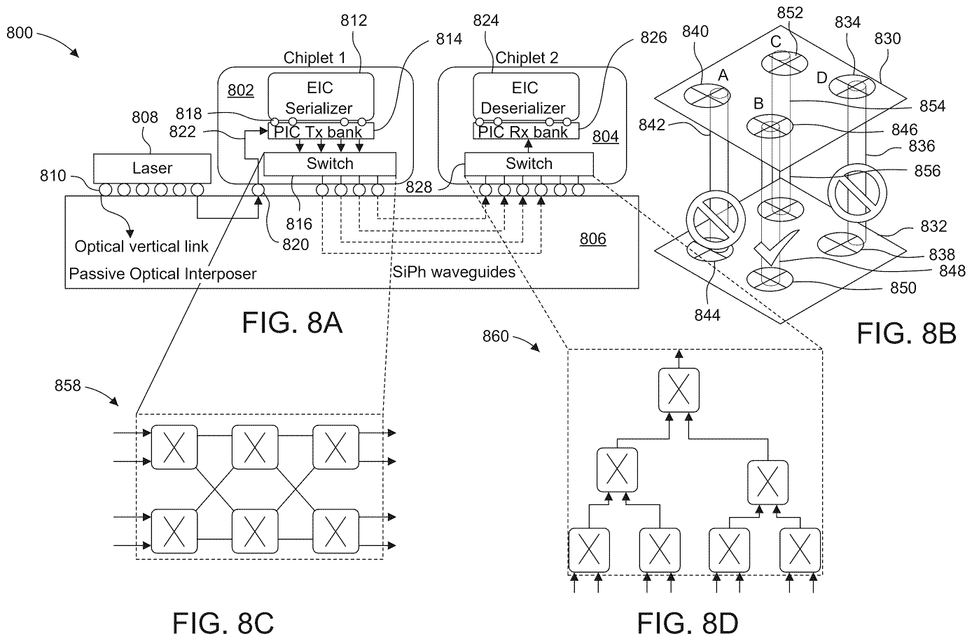

In some implementations, a chiplet of the plurality of chiplets 104, 106, 108, 110 may be coupled to the interposer 102 via one or more optical vertical links (OVLs), which are optical coupling structures that couple optical signals between a chiplet and the interposer in a direction perpendicular or substantially perpendicular to the plane of the interposer, providing a port to the interposer waveguides. OVL-based coupling is described further below (e.g., OVLs 722 of FIG. 7A, OVL interfaces 810, 820 of FIGS. 8A through 8D).

In some embodiments, the optical circuit switch 112 may be coupled to the plurality of waveguides 114 and configured to selectively establish circuit-switched optical connections among the chiplets through the waveguides. In some implementations, a circuit-switched optical connection may be established by programming the optical circuit switch 112 to direct an optical signal from one or more source chiplets to one or more destination chiplets through the ports and the interposer waveguides, wherein the connection may persist for a duration without requiring continuous reprogramming, until the control circuitry 124 programs a new configuration. In contrast to packet-switched connections in which routing decisions are made on a per-packet basis, the circuit-switched optical connections described herein may persist across multiple data exchanges without per-packet routing overhead. FIG. 1 shows example optical routes 118, 120, 122 as non-limiting illustrations of circuit-switched optical connections that can be established between chiplets by the optical circuit switch 112.

In some embodiments, the control circuitry 124 may be configured to program the optical circuit switch 112 to set a connectivity configuration that persists until reprogrammed; the connectivity configuration may include a set of switch states determining which chiplet pairs are connected. When a different connectivity pattern is desired, the control circuitry may reprogram the switch to a new connectivity configuration. Technologies suitable for implementing the control circuitry 124 include, but are not limited to, dedicated hardware controllers, application-specific integrated circuits (ASICs), firmware executing on embedded processors, and software executing on a general-purpose processor, photonic logic circuits, photonic processing elements, or hybrid electro-photonic control circuitry in which one or more control functions are implemented using photonic logic gates, photonic switching elements, or other photonic processing components.

In some implementations, the control circuitry 124 may program the optical circuit switch 112 to a connectivity configuration by setting the switch states of the individual switching elements that make up the switch. Once programmed, an optical signal from a source chiplet (e.g., chiplet 104) may propagate through the chiplet's port, enter a respective interposer waveguide, be routed through the optical circuit switch 112, exit through an output waveguide, and be received at the port of a destination chiplet (e.g., chiplet 106). The connectivity configuration may persist throughout data exchange without requiring the control circuitry 124 to continuously reprogram the switch. When the workload demands change and a different connectivity pattern is desired, the control circuitry 124 may reprogram the switch 112 to a new connectivity configuration.

In some embodiments, the circuit-switched architecture enables the interposer to be reconfigured to match the varying communication requirements of different applications, or different phases within a single application. Bandwidth can be directed dynamically to chiplet pairs that need to exchange large volumes of data, and then reconfigured to serve other communication demands, providing high bandwidth, low latency, and energy-efficient optical communication among chiplets. It is not necessary for every embodiment of the described technology to incorporate all of these advantages, and some embodiments may exhibit none of them.

In some embodiments, the optical circuit switch 112 may implement connections among the plurality of waveguides using a variety of switching network topologies. Topologies suitable for the optical circuit switch 112 include, but are not limited to, a butterfly topology (including modified butterfly topologies adapted to support one-to-many and many-to-one traffic patterns, for example by selectively removing switching elements and incorporating switching elements operable in a divide state), a crossbar topology, a Clos topology, a Benes topology, and a PILOSS topology. The choice of switching topology may be made based on system parameters including, for example, the number of chiplets, the required connectivity patterns, the allowable insertion loss, and fabrication constraints.

Some embodiments of the described technology have many advantages, including, but not limited to, the provision of high-bandwidth, low-latency, and energy-efficient optical communication among chiplets, the reduction of control overhead through persistent circuit-switched connections, and the ability to reconfigure the interconnect to match changing workload demands. It is not necessary for every embodiment of the described technology to incorporate all of these advantages, and some embodiments may exhibit none of them.

In some embodiments, the control circuitry 124 maintains precomputed switch configurations for a plurality of connectivity patterns and, responsive to a circuit-configuration command, retrieves and applies a precomputed switch configuration to program the optical circuit switch 112.

In some embodiments, a configuration table may be stored in memory accessible to the control circuitry 124. The configuration table may map connectivity pattern identifiers to corresponding precomputed switch configurations (e.g., the specific switch cell states that may be used to realize each connectivity pattern through the optical circuit switch 112). Memory types suitable for storing the configuration table include, but are not limited to, on-chip SRAM, off-chip DRAM, and flash memory, photonic memory elements such as optical flip-flops, phase-change photonic memory cells, or other photonic storage structures, and hybrid electro-photonic memory architectures.

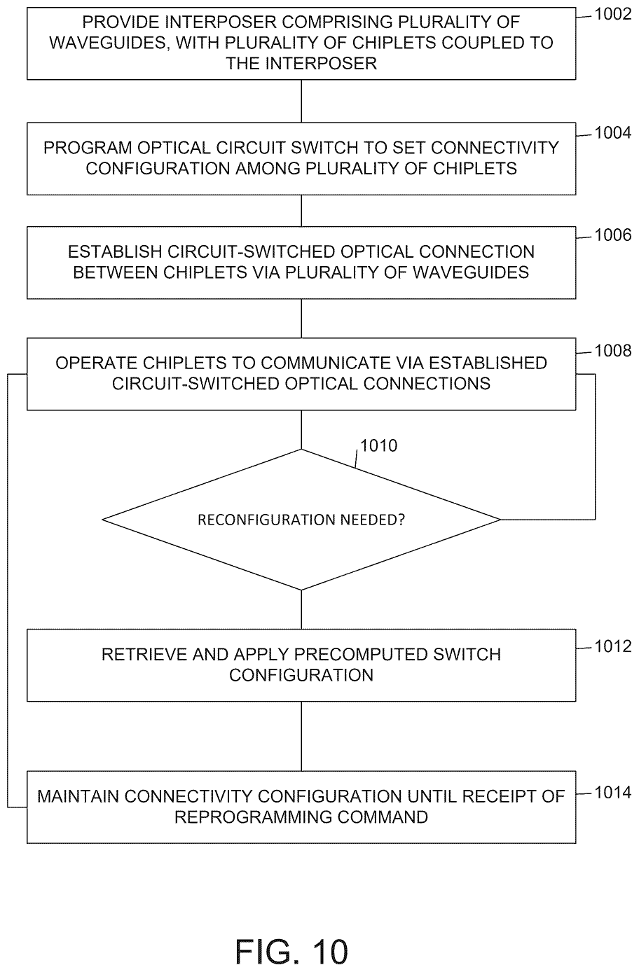

In some implementations, a circuit-configuration command may include a signal or instruction received by the control circuitry 124 specifying a desired connectivity pattern. Responsive to receiving such a command, the control circuitry 124: receives the circuit-configuration command specifying a connectivity pattern identifier P; looks up P in the configuration table; retrieves the corresponding precomputed switch configuration C; and applies C to program the optical circuit switch 112. Because the switch configuration is retrieved from the table rather than computed at runtime, this approach reduces switch programming latency compared to on-the-fly computation. Referring to FIG. 10, this retrieval and application step corresponds to block 1006 of the method described below.

In some embodiments, the control circuitry 124 programs all MZI switch cells of the optical circuit switch simultaneously in a single programming event, such that the control-plane decision latency associated with selecting and applying a switch configuration does not significantly increase with switch size. The physical settling time of the phase shifters, which depends on implementation-specific factors including electrical fan-out, RC loading, and the settling characteristics of the chosen phase-shift mechanism, may vary with fabric size and is distinct from the control-plane decision latency. In some embodiments, the switch configuration decision is made in a single clock cycle at an operating frequency of approximately 2 GHz (e.g., where the single-cycle timing refers to the control-plane decision and not to the physical settling of the phase shifter). Implementations may have switch fabric size of any suitable scale. For example, the size may be bounded by the number of chiplets that can be integrated on a given interposer. In some examples, such as those employing chiplet-based optical switches, the switch fabric may be implemented as a modular array of switch chiplets, each controlled independently, enabling the aggregate switch port count to be scaled beyond what a single monolithic switch fabric would permit while preserving single-cycle control-plane decision latency per switch chiplet.

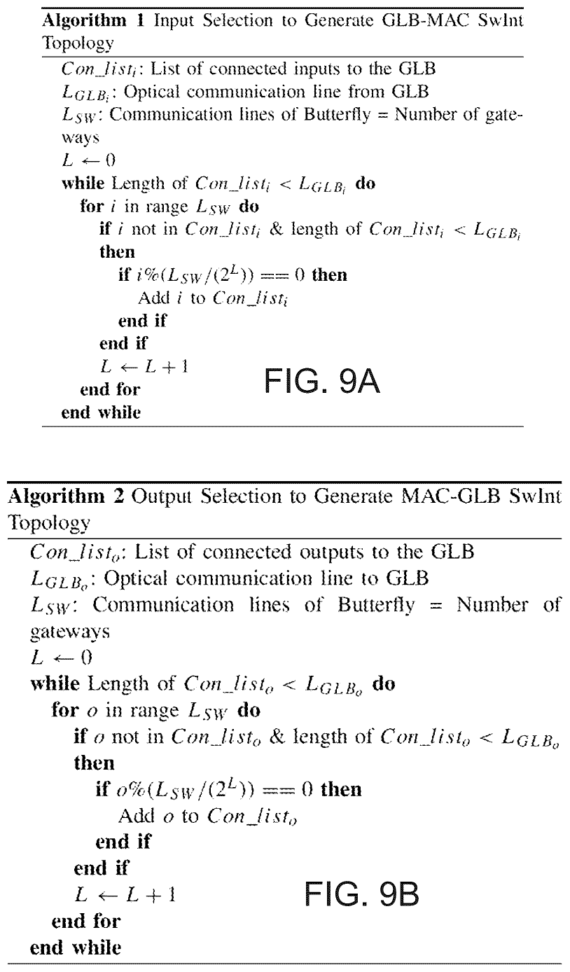

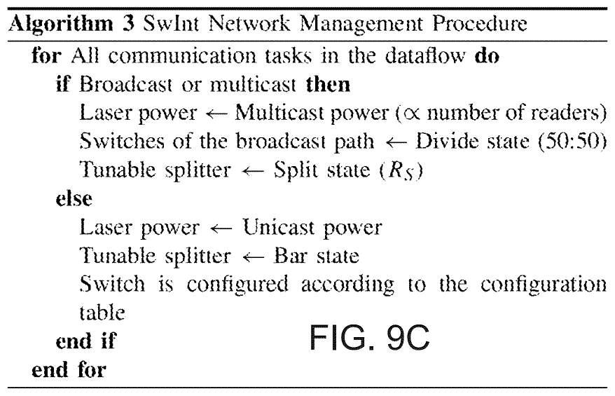

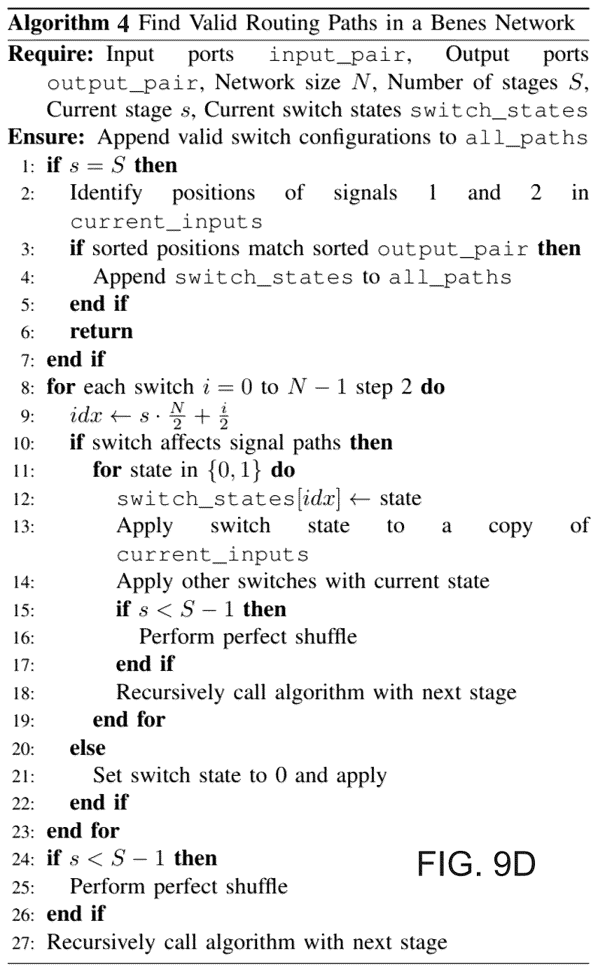

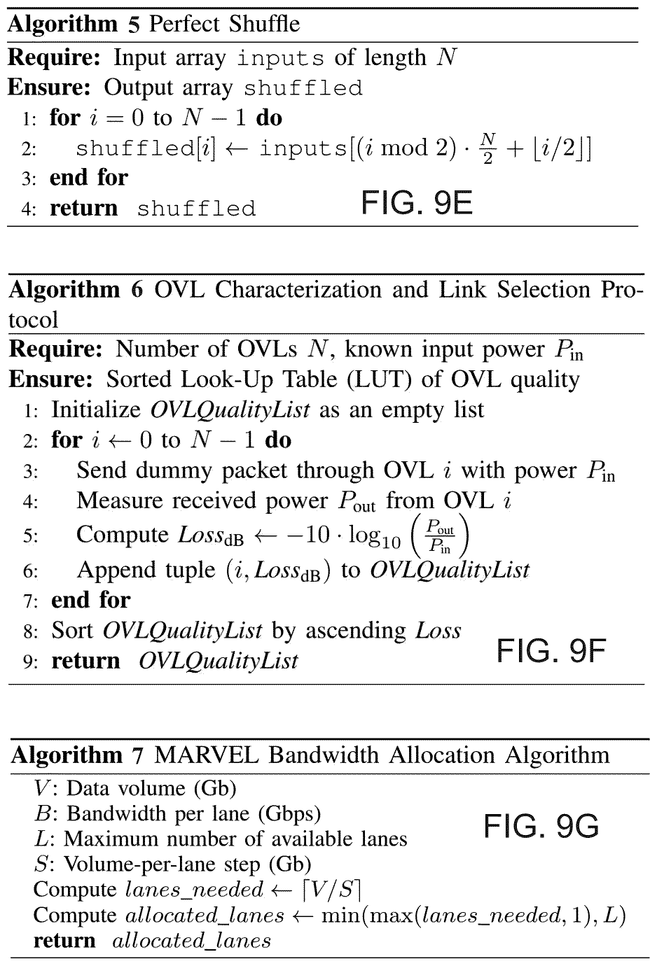

The configuration table can be populated offline (prior to runtime) using routing analysis of the type described below with reference to FIGS. 9A and 9B, or can be updated dynamically during operation as new connectivity patterns are encountered. In some embodiments, the table is populated during system initialization and remains fixed during a given operating session. In other embodiments, the control circuitry computes switch configurations online at runtime. In still other embodiments, a hybrid approach is used in which precomputed configurations are retrieved for known patterns and online computation is used as a fallback for patterns not present in the table.

The following paragraphs describe an example implementation of the system 100 in which the interposer 102 may be an active silicon photonic interposer, that is, an interposer in which the waveguides and the optical circuit switch are integrated monolithically on a silicon photonic substrate. Features of this implementation may include, for example, a custom butterfly switching topology optimized for the one-to-many and many-to-one traffic patterns between a memory chiplet and a plurality of MAC chiplets, a divide state in the MZI switch cell enabling broadcast and multicast connectivity from the memory chiplet to multiple MAC chiplets without additional splitting components, non-blocking input selection and input swapping mechanisms for blocking avoidance, and an inverse-designed MMI coupler and adiabatic microring resonator for high-performance device implementation.

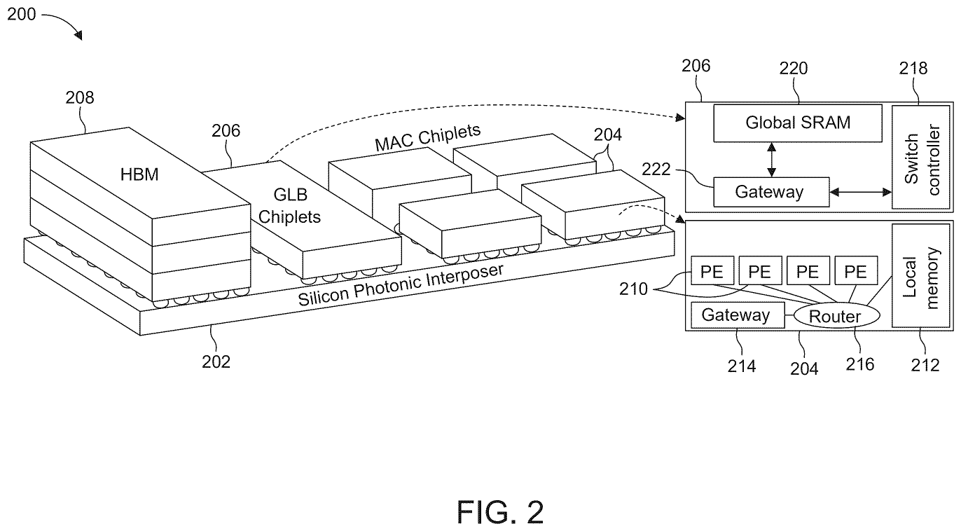

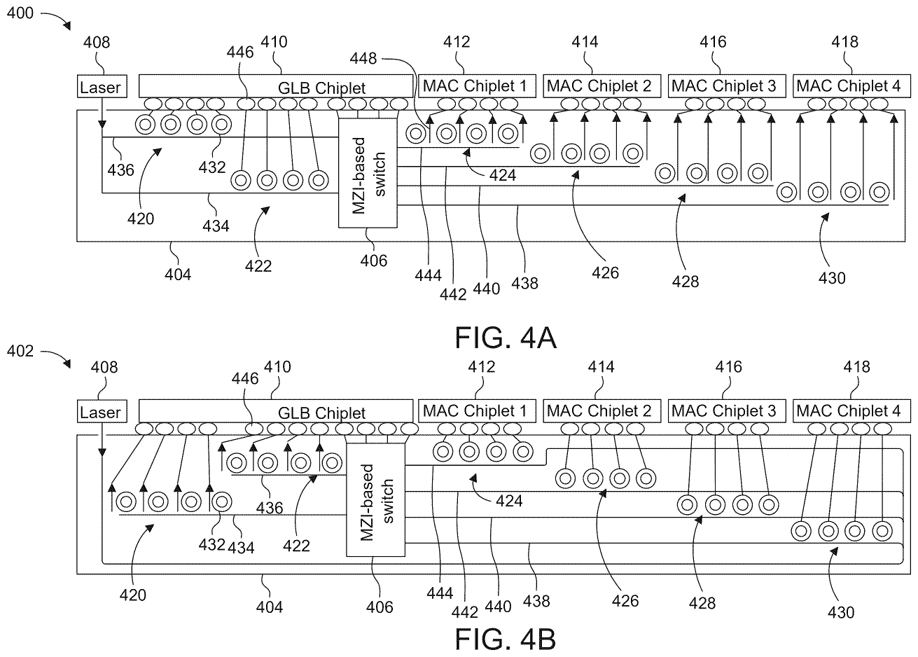

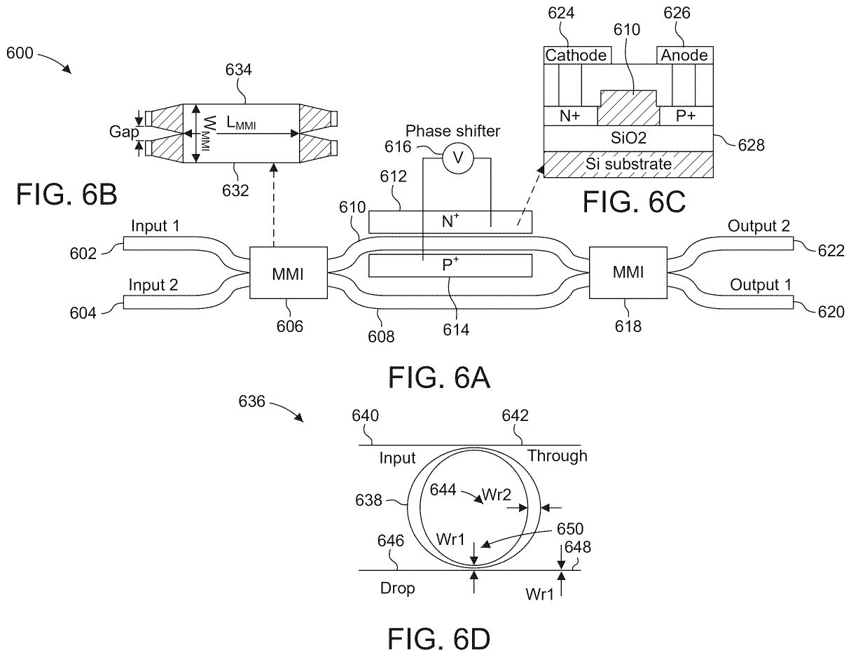

Referring to FIG. 2, an embodiment of a chiplet system architecture 200 is shown in which the interposer is an active silicon photonic interposer 202. The system architecture 200 is an embodiment of the system 100 of FIG. 1 in which the optical circuit switch 112 may be integrated monolithically with the waveguides 114 on the silicon photonic substrate of the active interposer 202. In some embodiments, the waveguides may be silicon waveguides. In other embodiments, silicon nitride or other low-loss waveguide materials are used. In some embodiments, the system architecture 200 further includes microring resonators, such as adiabatic microring resonators (AMRs), at chiplet gateway interfaces for wavelength-selective filtering and optical modulation, as described further below with reference to FIGS. 6B and 4A-4B. In some embodiments, chiplets in the active interposer system 200 may be coupled to the active interposer 202 via optical vertical links (OVLs) as an alternative to, or in combination with, optoelectronic ports, providing direct optical coupling between the chiplets and the interposer waveguides.

In some embodiments, the system architecture 200 may include a plurality of MAC chiplets 204 and at least one memory chiplet 206. Each MAC chiplet 204 may be a processing chiplet configured to perform multiply-accumulate operations, for example in the context of machine-learning (ML) inference workloads. In some embodiments, each MAC chiplet 204 includes an array of processing elements, local memory, routers, and a gateway interface to the interposer 202. The gateway interface may handle electrical-to-optical and optical-to-electrical domain conversion, buffering, flow control, and broadcast support. In some embodiments, each MAC chiplet 204 includes an array of processing elements 210, local memory 212, a gateway 214 providing an interface to the interposer 202, and a gateway-router 216. Computing resources suitable for implementation in a MAC chiplet 204 include, but are not limited to, systolic array processors, vector processing units, and matrix multiply accelerators, photonic multiply-accumulate units, photonic tensor processing elements, and hybrid electro-photonic processing architectures in which one or more computational functions are performed in the optical domain.

In some embodiments, the memory chiplet 206 may be a memory chiplet, such as a high-bandwidth memory (HBM) chiplet, that stores and distributes data—for example, neural network weights in an ML inference workload—to the MAC chiplets 204 via the optical circuit switch and the interposer waveguides, and may receive processed results from the MAC chiplets. In some embodiments, the memory chiplet 206 includes global SRAM 220 or high-bandwidth memory (HBM) (or photonic memory in some embodiments), a switch controller 218, and a gateway 222 for interposer communication. The memory chiplet 206 may interface with high-bandwidth memory 208 (e.g., HBM) for large-capacity data storage beyond the capacity of on-chiplet SRAM.

For example, a traffic pattern in the system architecture 200 may be one-to-many in the memory-to-MAC direction, wherein the memory chiplet distributes data or weights to multiple MAC chiplets simultaneously or sequentially, and many-to-one in the MAC-to-memory direction, wherein multiple MAC chiplets return processed results to the memory chiplet. In some implementations, the interposer optical network may be organized into two directed sub-networks corresponding to these two traffic directions, as described further below. The memory-to-MAC and MAC-to-memory traffic patterns described herein are representative examples motivated by ML inference workloads and are not required system properties. Other embodiments may implement different traffic patterns, including many-to-many, peer-to-peer, or other application-specific communication topologies, using the same optical circuit switch architecture.

In some embodiments, a hybrid architecture combines switch-based optical routing with bus-based links at switch output ports, allowing multiple MAC chiplets to share an output while reducing the number of required switch stages. The bus-hybrid approach trades reduced switch complexity for increased filter losses and higher laser power requirements, and can be advantageous in configurations with a small number of wavelengths or chiplets per output.

In some embodiments in which the interposer is an active silicon photonic interposer, the optical circuit switch comprises a plurality of Mach-Zehnder interferometer (MZI) switch cells. Referring to FIG. 6A, an embodiment of an MZI switch cell 600 is shown. The MZI switch cell 600 comprises a first input 602, a second input 604, an input MMI coupler 606, a first waveguide arm 610 coupled between the input MMI coupler 606 and an output MMI coupler 618, and a second waveguide arm 608 coupled between the input MMI coupler 606 and the output MMI coupler 618. The first waveguide arm 610 includes a phase shifter region. The output MMI coupler 618 is coupled to a first output 620 and a second output 622.

In some embodiments, the input MMI coupler 606 and the output MMI coupler 618 are multi-mode interference (MMI) couplers configured to provide a uniform 50/50 optical splitting ratio across a broad wavelength range. In some embodiments, the MMI couplers are optimized using inverse design, for example via particle swarm optimization (PSO) combined with finite-difference time-domain (FDTD) electromagnetic simulation, to achieve uniform splitting across the full C-band (approximately 1530 nm to 1560 nm). The PSO/FDTD-optimized MMI coupler dimensions provide fabrication-tolerant performance, maintaining the desired 50/50 splitting ratio over a range of fabrication process variations. In one example fabricated embodiment, the PSO/FDTD-optimized MMI coupler dimensions are: L_MMI=17.1 μm, W_MMI=2.2 μm, and L_Taper=4.37 μm, with taper shape parameters m=1.75, w₁=500 nm, w₂=1.08 μm, and a gap of 680 nm between input waveguides. In some embodiments, the input MMI coupler 606 includes a first MMI access waveguide 632 and a second MMI access waveguide 634 coupling the input waveguides to the multimode interference region. Providing, in this example fabricated embodiment, a worst-case transmission loss of approximately 0.02 dB per coupler and a power splitting imbalance of less than 0.14 dB across the C-band in simulation, and a measured insertion loss of approximately 0.17 dB at the central operating wavelength with a maximum power imbalance tolerance of less than 0.5 dB across fabricated devices. These loss values are specific to the example fabricated embodiment and may vary with process node, waveguide platform, wavelength range, and tuning mechanism. Coupler types suitable for use as the input MMI coupler 606 and the output MMI coupler 618 in the MZI switch cell 600 include, but are not limited to, MMI couplers, directional couplers, and Y-branch splitters. In some embodiments, the MMI couplers are fabricated using a 220 nm silicon-on-insulator (SOI) process, for example through a silicon photonic foundry utilizing SOI technology.

The first waveguide arm 610 includes an N-doped semiconductor region 612 and a P-doped semiconductor region 614 configured to provide a controlled phase shift between the first waveguide arm 610 and the second waveguide arm 608. In some embodiments, the phase shift is induced via carrier injection or carrier depletion in a p-n junction formed by the N-doped semiconductor region 612 and the P-doped semiconductor region 614 embedded in the waveguide core of the first waveguide arm 610. The N-doped semiconductor region 612 and the P-doped semiconductor region 614 form a p-n junction embedded in the waveguide core of the first waveguide arm 610. By applying a voltage across the junction via a driver 616 through a cathode 624 and an anode 626, carriers (electrons and holes) are injected into or depleted from the silicon waveguide region, modifying the carrier concentration and thereby altering the refractive index of the waveguide through the plasma dispersion effect. Light traveling through the carrier-injected region experiences a different optical path length compared to light in the unmodified arm, producing a phase difference between the first waveguide arm 610 and the second waveguide arm 608 that determines the operative switch state. In one example fabricated embodiment, the MZI switch cell 600 achieved a worst-case insertion loss of approximately 0.12 dB in the cross state and approximately 0.5 dB in the bar state using electro-optical tuning, with a V_π of approximately 1.3 V, waveguide arm lengths of approximately 200 μm, and a switching time of approximately 5.7 ns. These values are specific to the example fabricated embodiment and may differ across process nodes, waveguide platforms, and phase-shift mechanisms. In some embodiments, the MZI switch cell 600 is formed on a silicon oxide or silicon substrate 628. Phase-shift mechanisms suitable for use in the MZI switch cell 600 include, but are not limited to, carrier injection via p-n or p-i-n junctions, thermo-optic phase shifters, electro-optic phase shifters, and MEMS-actuated phase shifters.

In some embodiments, the MZI switch cell 600 may support three operative switch states, selected by setting the phase difference Δφ:

Cross state: When Δφ is set to approximately 0 (zero applied bias), an optical signal entering the first input 602 may exit the first output 620, and a signal entering the second input 604 may exit the second output 622. The signal may be directed across the switch cell. In some implementations, the cross state may be the default state of the MZI switch cell 600 under zero or low applied bias.

Bar state: When Δφ is set to approximately π, an optical signal entering the first input 602 may exit the second output 622, and a signal entering the second input 604 may exit the first output 620. The signal may pass straight through the switch cell without deflection. In optical implementations, the bar state may be induced by applying a π phase shift and may exhibit lower insertion loss and lower power consumption than the cross state in certain electro-optic implementations, motivating loss-aware routing that maximizes the use of bar-state switch cells where such a loss advantage exists.

Divide state: When Δφ is set to approximately π/2, the optical signal may be split approximately equally between the first output 620 and the second output 622. This third operative state, beyond the conventional cross and bar states of a standard 2×2 MZI switch, may enable broadcast and multicast connectivity through the switch fabric without requiring additional passive optical splitter components. In some implementations, the divide state may cause the MZI switch cell 600 to function as an active 3-dB optical splitter, splitting the optical signal into two substantially equal-power branches that may propagate through the switch fabric independently. The control circuitry 124 may program each MZI switch cell 600 to a desired state by directing the driver 616 to apply the appropriate voltage or current to the N-doped semiconductor region 612 and the P-doped semiconductor region 614. In some embodiments, a single programming event may set different cells in the switch fabric to different states simultaneously. The divide-state operation introduces trade-offs relative to cross-state and bar-state operation, including additional phase-shifter-induced insertion loss at each divide-state cell, cumulative power splitting loss across multiple stages of the switch fabric, and correspondingly higher laser power requirements to maintain adequate received optical power at each destination chiplet. The laser power scaling and insertion loss penalties associated with divide-state broadcast are implementation-dependent and increase with the number of switch stages traversed in the broadcast tree.

In some embodiments, the power imbalance between the two outputs of an MZI switch cell 600 operating in the divide state introduces a non-ideal signal split that affects the uniformity of broadcast signal distribution. However, because the number of switch stages does not increase linearly with the number of switch outputs, and because device-level optimization minimizes the per-cell imbalance, the total optical loss attributable to imbalance does not increase linearly as the size of the switch fabric grows. In one example fabricated embodiment, the maximum power imbalance between the two outputs of a divide-state MZI switch cell was approximately 0.5 dB, as determined by fabricated device characterization. This value is specific to the example fabricated embodiment and may vary with process, wavelength, and coupler design.

Referring to FIG. 6B, an embodiment of an adiabatic microring resonator (AMR) 636 is shown. In some embodiments, the AMR 636 may be used as an optical modulator or wavelength-selective filter at chiplet gateway interfaces. The AMR 636 may be characterized by an adiabatically varying coupling profile between a bus waveguide and the ring waveguide 638, which may reduce the resonator's sensitivity to fabrication-induced waveguide variations compared to conventional microring resonators having a uniform coupling gap. The AMR 636 may include an input port 640, a through port 642, a drop port 646, and an add port 648.

In one example fabricated embodiment the AMR 636 has the following approximate dimensions: a first ring waveguide width W_r1 of approximately 500 nm and a second ring waveguide width W_r2 of approximately 850 nm, wherein W_r2 is greater than W_r1 and the adiabatically varying width profile is defined between these two values, a coupling gap between the bus waveguide and the ring waveguide 638 of approximately 100 nm, and a ring radius of approximately 10 μm (such values are provided by way of example and are not limiting). The ring waveguide 638 includes a wider width region 644 proximal to the bus waveguide and a narrower width region 650 proximal to the drop port 646 and the add port 648, defining the adiabatically varying coupling profile. The interior wall design of the AMR 636 effectively suppresses higher-order radial modes that propagate in conventional microring resonator designs, ensuring that only the lowest-order radial mode propagates through the ring and eliminating the adverse effects associated with higher-order radial modes. The adiabatically varying coupling profile results in a reduced average resonant wavelength shift (ΔΛR) across fabrication process corners compared to conventional microring resonators—in the example fabricated embodiment achieving approximately a 50% reduction in average wavelength shift—thereby reducing the tuning power required to compensate for fabrication variation. The AMR 636 further exhibits a wide, uncorrupted free spectral range (FSR), in the example fabricated embodiment approximately 9.9 nm with a channel spacing of approximately 0.62 nm across 16 wavelengths, which is beneficial for applications requiring broad optical bandwidth. The average through-port loss per AMR was measured at approximately 0.02 dB, with a measured drop loss of approximately 0.5 dB. These values are specific to the example fabricated embodiment and may vary with process node, ring geometry, and operating conditions. Through-port and drop-port loss characteristics of the AMR 636 are suitable for use as a modulator or wavelength-selective demultiplexer in a WDM chiplet interface.

In some embodiments, thermo-optic tuning is employed for trimming the resonant frequencies of the AMRs to compensate for thermal and process variations, leveraging its broader tuning range relative to other tuning mechanisms. Each MRR filter and modulator is analyzed to verify frequency resonance accuracy, and where deviations are detected due to process or thermal factors, tuning circuits apply a voltage to heaters to adjust the resonant frequency of the affected MRR and align it with the expected operating frequency.

In some embodiments, the AMR 636 is configured as an optical modulator operating at a modulation frequency of approximately 12 GHz, which mitigates resonance shifts caused by fabrication variations compared to lower-speed modulator designs. Resonator types suitable for chiplet gateway interfaces in the active interposer embodiment include, but are not limited to, adiabatic microring resonators, conventional microring resonators, racetrack resonators, and electro-absorption modulators.

Referring to FIGS. 4A and 4B, two directed optical sub-networks of the active interposer system may be provided, as shown—a memory-to-MAC network 400 (FIG. 4A) and a MAC-to-memory network 402 (FIG. 4B)—which may together implement full bidirectional optical connectivity between the memory chiplet and the MAC chiplets on the active interposer substrate 404.

In some embodiments, each microring resonator bank includes one or more example microring resonators 432. Multi-wavelength waveguides 434 and 436 couple the laser source 408 to the microring resonator banks 422 and 420, respectively. Waveguides 438, 440, 442, and 444 couple the outputs of the MZI-based optical circuit switch 406 to the microring resonator banks 430, 428, 426, and 424, respectively. Solder bumps 446 provide the electrical interface each chiplet and the interposer substrate 404, and in some embodiments implement optoelectronic ports through which each chiplet transmits electrical signals to modulators integrated on the interposer substrate 404 for optical signal generation and transmission onto the interposer waveguides, and photodiodes 448 provide optoelectronic conversion at the receiving chiplet interfaces. In some embodiments, one or more chiplets of the active interposer system may alternatively be coupled to the interposer substrate 404 via optical vertical links (OVLs), providing direct optical coupling between the chiplet and the interposer waveguides without intermediate electrical-to-optical conversion at the interposer interface.

In some embodiments, the memory-to-MAC network 400 (FIG. 4A) may comprise an MZI-based optical circuit switch 406, a laser source 408, a memory chiplet 410, MAC chiplets 412, 414, 416, and 418, and microring resonator banks 420, 422, 424, 426, 428, and 430. The MZI-based optical circuit switch 406 may be, for example, a multi-stage array of MZI switch cells 600 arranged in a butterfly switching topology.

In some embodiments, the butterfly topology may be selected to minimize the number of switch stages required to connect the memory chiplet to any MAC chiplet—or to broadcast to multiple MAC chiplets simultaneously—for the one-to-many traffic pattern of ML inference workloads. Minimizing the number of switch stages may reduce the total optical insertion loss through the switch fabric and thereby reduces the required laser power and interposer footprint, compared to fully non-blocking Clos or crossbar topologies for this specific traffic pattern. In some embodiments, the switch fabric contains ┌ log2(N)┐ stages for N output ports, with each MZI switch cell 600 at each stage routing or splitting the optical signal toward one or both of the output chiplets assigned to that stage. Switching network topologies suitable for the MZI-based optical circuit switch 406 include, but are not limited to, the butterfly topology, a crossbar topology, a Clos topology, a Benes topology, and a PILOSS topology.

In some embodiments, the laser source 408 may provide one or more continuous-wave (CW) optical carriers for the memory-to-MAC sub-network. Laser source types suitable for the laser source 408 include, but are not limited to, a multi-wavelength comb laser providing a plurality of evenly spaced CW carriers for wavelength-division multiplexed operation, a single-wavelength distributed feedback (DFB) laser, an array of single-wavelength lasers, and heterogeneously integrated laser chiplets disposed adjacent to or on the interposer. In some embodiments a single laser source feeds the entire switch network via a waveguide bus; in other embodiments multiple laser sources are used, or laser chiplets are integrated adjacent to the interposer.

In some implementations, the memory chiplet 410 may be coupled to the input of the MZI-based optical circuit switch 406. The memory chiplet 410 may modulate the CW optical carrier from laser source 408 to encode data for transmission to the MAC chiplets 412, 414, 416, 418.

In some embodiments, each of the MAC chiplets 412, 414, 416, 418 may be coupled to a respective output of the MZI-based optical circuit switch 406. Each MAC chiplet's gateway may include a microring resonator bank (420, 422, 424, 426, 428, or 430) that may act as a wavelength-selective filter, selecting the optical channel or channels directed to that chiplet by the switch, and a photodetector for O/E conversion.

The MAC-to-memory network 402 (FIG. 4B) uses a second MZI switch arrangement on the same interposer substrate 404, with the inputs and outputs transposed relative to the memory-to-MAC network 400, to support the many-to-one return traffic pattern from MAC chiplets to the memory chiplet. In some embodiments, the MAC-to-memory direction employs wavelength-division multiplexing (WDM) to increase aggregate bandwidth, with each MAC chiplet including a modulator bank and the memory chiplet including a photodetector bank and aggregation circuitry. the laser source 408 may generate a CW optical carrier; the memory chiplet 410 may modulate the carrier to encode data; the modulated signal may enter the MZI-based optical circuit switch 406; the switch may route or broadcast the signal to the selected MAC chiplet output port or ports according to the programmed connectivity configuration; each receiving MAC chiplet's microring resonator bank may select the arriving optical channel and the chiplet's photodetector may perform O/E conversion. The MAC-to-memory network 402 may operate analogously in the reverse direction, with MAC chiplets as sources and the memory chiplet as destination

In some embodiments, bus-based links are added at switch output ports, allowing multiple MAC chiplets to share an output while reducing the number of required switch stages—at the cost of increased filter losses and higher laser power requirements.

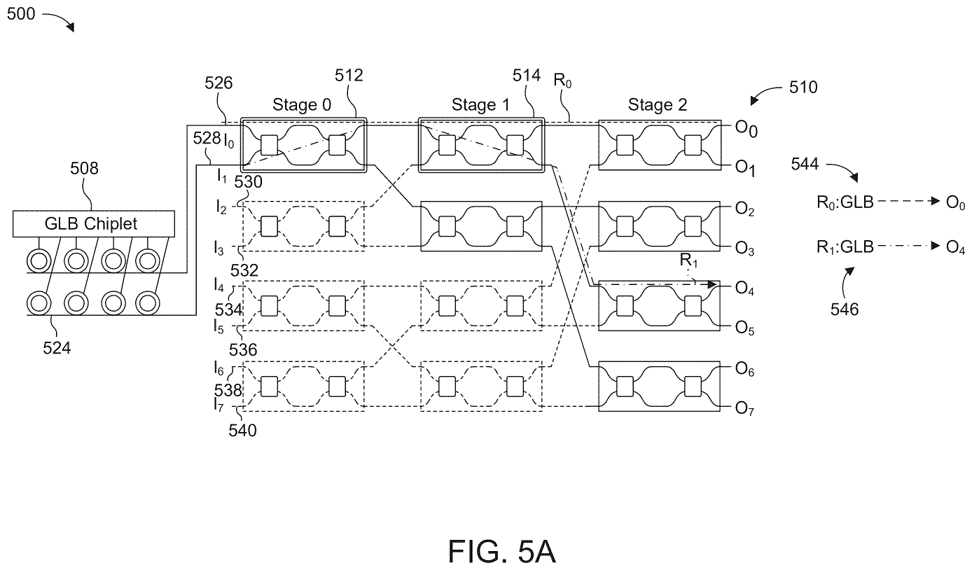

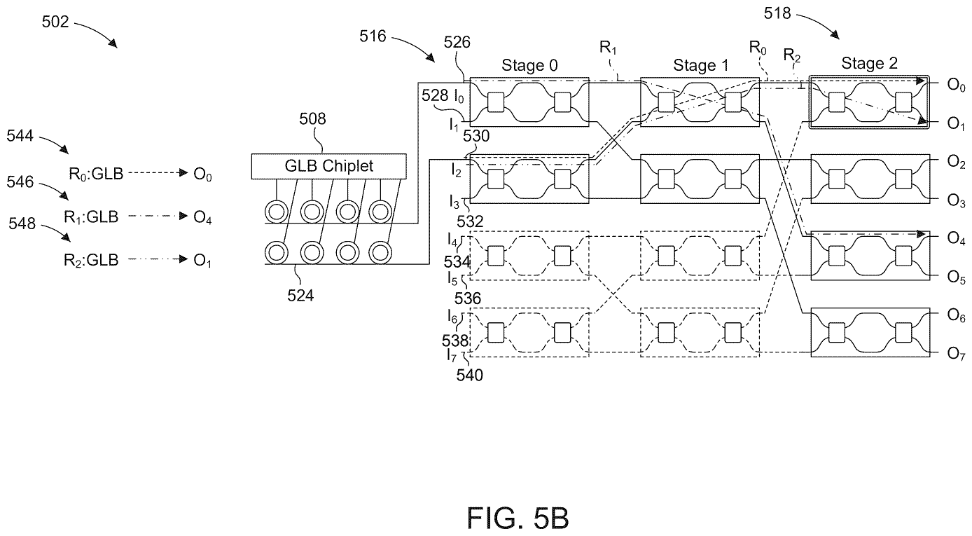

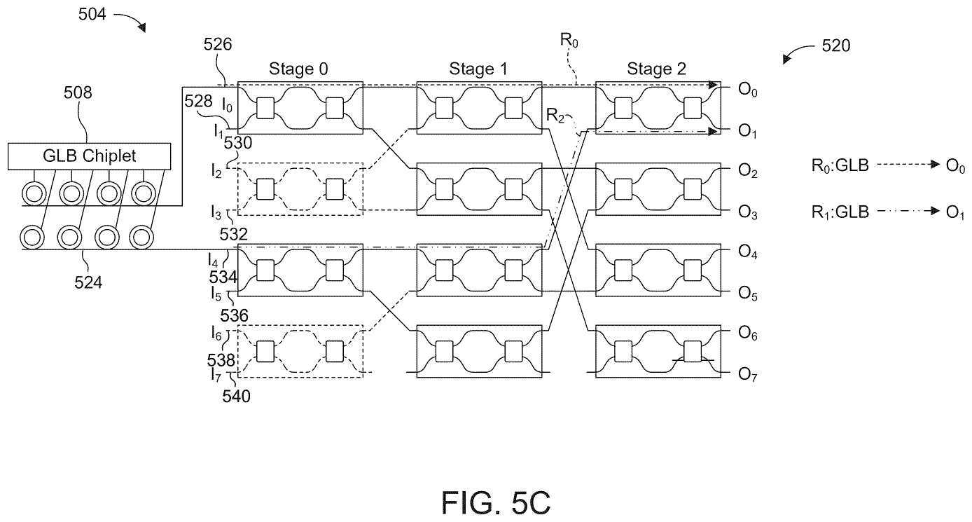

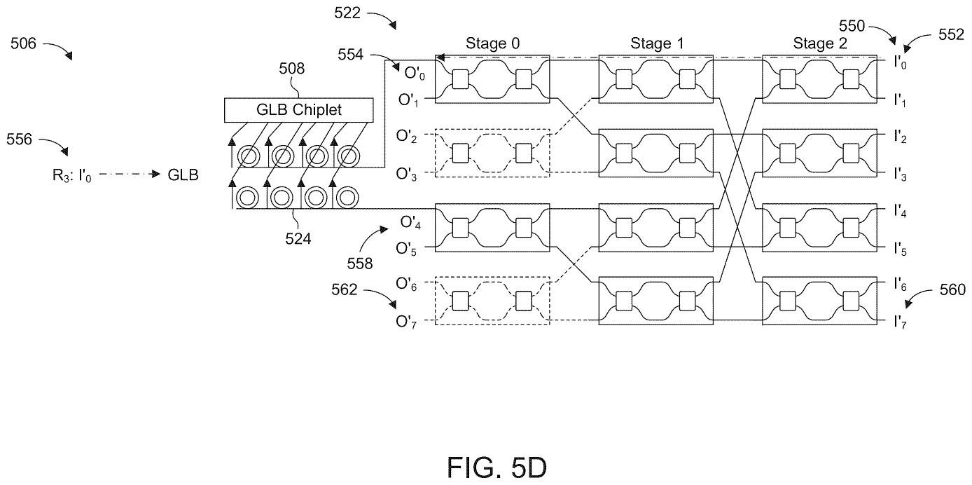

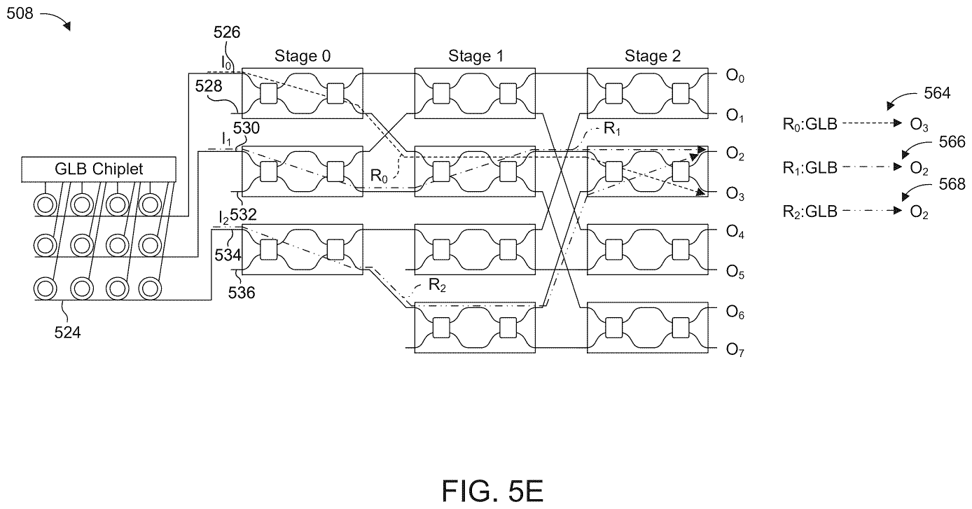

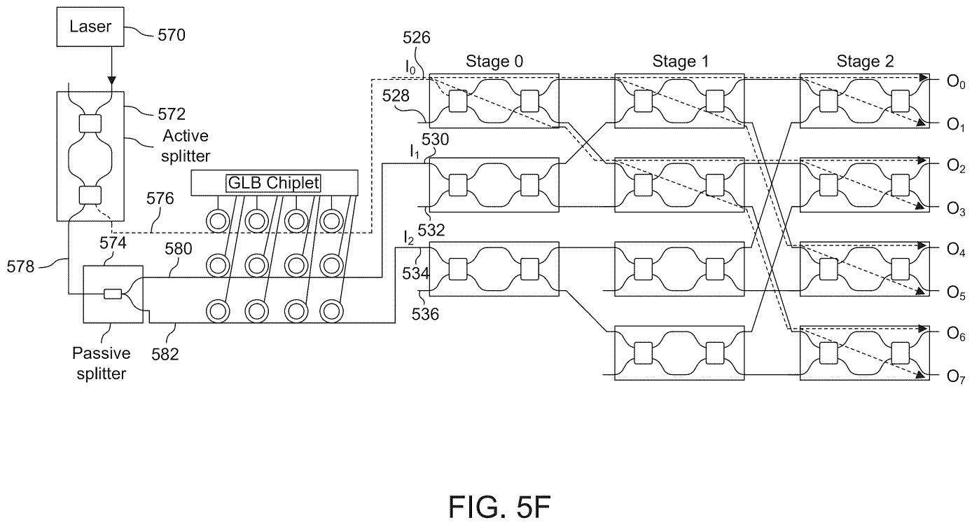

In some implementations, the butterfly switching topology, while minimizing switch stages and optical insertion loss for the one-to-many traffic pattern, may exhibit blocking for some input-port assignment configurations. Blocking may occur when certain combinations of simultaneous connection requests cannot be satisfied without signal path collisions in the switch fabric. FIGS. 5A through 5F illustrate the blocking problem and the mechanisms used to resolve it through input-port selection and input swapping.

Referring to FIG. 5A, a first network topology example 500 illustrates a suboptimal input selection in which Route 0 (544) and Route 1 (546) create a blocking condition at MZI switch components 512 and 514 within MZI switch 510. The memory chiplet 508 is coupled to the switch via first and second input waveguides 526 and 528, with pairs of inputs 530, 532, 534, 536, 538, and 540 feeding Stage 0 MZI switch cells. Microring resonators 524 are shown at the output ports. Referring to FIG. 5B, a second network topology example 502 illustrates a suboptimal input selection in which Route 0 (544) and Route 2 (548) create a blocking condition at MZI switch component 518 within MZI switch 516. Referring to FIG. 5C, an optimized network topology 504 for memory-to-MAC communication illustrates a non-blocking configuration in which Route 0 (544), Route 1 (546), and Route 2 (548) are established simultaneously through MZI switch 520 without blocking. Referring to FIG. 5D, an optimized network topology 506 for MAC-to-memory communication illustrates the reverse communication direction through MZI switch 522. Referring to FIG. 5E, an input swapping example illustrates Route 0 (564), Route 1 (566), and Route 2 (568) established through MZI switch 520 after input port reassignment. Referring to FIG. 5F, a broadcast network configuration illustrates a laser 570 coupled to an active splitter 572 and a passive splitter 574, with an inactive output 576 and an active output waveguide 578 of the active splitter 572, and waveguides 580 and 582 distributing the broadcast signal through MZI switch 520 to the microring resonators 524 at the output ports.

Referring to FIGS. 5A through 5C, example routing configurations are shown that may arise from an initial input-port assignment where blocking may occur for certain connectivity patterns. When two chiplets requiring simultaneous connections are assigned to input ports that share the same internal switch path through the butterfly fabric, their signals may collide at an intermediate switch cell, potentially preventing one or both connections from being established correctly.

Referring to FIGS. 5D through 5E, in some embodiments, the control circuitry 124 may resolve blocking by swapping the input-port assignments of two or more chiplets. For example, if MAC chiplets assigned to inputs I0 and I1 create a blocking collision for a desired connectivity pattern, assigning the same chiplets to inputs I0 and I2 instead may yield a non-blocking path through the switch fabric. Referring to FIG. 5E, Route 0 (564), Route 1 (566), and Route 2 (568) illustrate the resulting non-blocking configuration after input port reassignment. The non-blocking configuration may then be stored in the configuration table for retrieval at runtime.

In some embodiments, the control circuitry 124 may employ two mechanisms for blocking avoidance:

Input selection: In some implementations, the control circuitry 124 may assign chiplets to switch input ports in an order that avoids blocking for the anticipated set of connectivity patterns. This assignment may be performed offline (prior to runtime) using routing analysis that enumerates candidate input-port assignments and identifies those for which non-blocking configurations exist for all required connectivity patterns.

Input swapping: In some implementations, when a blocking configuration is detected for a given connectivity pattern under the current input-port assignment, the control circuitry 124 may swap the input-port assignments of two or more chiplets to obtain a non-blocking routing path through the switch fabric, and may record the non-blocking configuration in the configuration table for future runtime use.

Referring to FIG. 9A, Algorithm 1 describes an example input selection procedure for the memory-to-MAC network 400 of FIG. 4A. In some embodiments, Algorithm 1 may enumerate candidate input-port assignments for the set of chiplets requiring connections, determines for each candidate assignment whether a non-blocking routing path exists through the butterfly switch fabric for all required connectivity patterns, and for each assignment yielding a non-blocking configuration, records the input-port assignment and the corresponding switch cell states in the configuration table. If blocking is detected under a candidate assignment, the algorithm may swap input-port assignments and repeat the evaluation. Referring to FIG. 9B, Algorithm 2 may perform the analogous procedure for the MAC-to-memory network 402 of FIG. 4B, selecting output-port assignments and recording non-blocking configurations for the return direction. In some implementations, both algorithms may operate offline to populate the configuration table used by the control circuitry 124 during runtime operation. In some embodiments, the algorithms are executed on a host processor during system initialization. In other embodiments, they are re-executed when the system configuration changes.

The foregoing blocking avoidance approach is illustrated in FIGS. 5A through 5F, which show a progression from a first routing configuration (FIG. 5A) through a fifth routing configuration (FIG. 5E) arriving at progressively less-blocking configurations, and FIG. 5F showing the broadcast configuration described below.

Routing approaches suitable for alternative embodiments include, but are not limited to, online routing computation at runtime, recursive backtracking, and exhaustive lookup-table approaches. The number of chiplets, input ports, and output ports can vary.

Referring to FIG. 5F, in some embodiments the optical circuit switch 406 of the active interposer system 200 is programmed to establish one-to-many (broadcast or multicast) circuit-switched optical connections by programming a set of MZI switch cells 600 to the divide state, while simultaneously programming other MZI switch cells to cross or bar states to establish one-to-one (unicast) connections.

In some embodiments, in one-to-many operation, an MZI switch cell 600 programmed to the divide state may split the optical signal at that point in the switch fabric into two substantially equal-power branches. Subsequent divide-state cells may further split each branch, producing a tree-like power distribution through the switch stages that delivers the optical signal to multiple destination MAC chiplets simultaneously. A single programming event may simultaneously set the relevant cells to the divide state and the unicast cells to the cross or bar state. The control circuitry 124 may monitor which communication tasks require one-to-many connectivity and may program the switch accordingly. One-to-many operation via divide-state MZI switch cells incurs cumulative insertion loss and power splitting penalties that increase with the number of divide-state stages traversed, requiring correspondingly higher laser source power to maintain adequate received optical power at each destination chiplet.

In some embodiments, an MZI switch cell at the input of the first stage of the butterfly fabric is programmed to the divide state and functions as an active optical splitter (e.g., active splitter 572 of FIG. 5F), directing the entire input power of the laser source to the broadcast line to ensure sufficient optical power is available for all intended destination chiplets. Passive optical splitters (e.g., passive splitter 574 of FIG. 5F) within the subsequent switch stages further divide the signal along the broadcast tree path, with all switch cells along the tree path configured to the divide state simultaneously. The laser source (e.g., laser 570 of FIG. 5F) power is dynamically tuned during broadcast operation to compensate for the cumulative power splitting at each divide-state cell, ensuring adequate received optical power at each destination chiplet. The total laser power required for broadcast operation may be substantially higher than for unicast operation due to the cumulative power splitting at each divide-state cell and the phase-shifter-induced insertion loss at each active MZI switch cell along the broadcast tree path. In some embodiments, a splitting ratio R_S=1/(L_mem−1) is applied at the active splitter, where L_mem denotes the number of memory chiplet communication lines, such that for L_mem=5 lines a splitting ratio of 0.25 is used. In some embodiments, during a broadcast period the switch is dedicated to the broadcast task and simultaneous unicast connections through switch cells in the divide state are not established; in other embodiments, one-to-one and one-to-many connections are established simultaneously on disjoint subsets of switch cells.

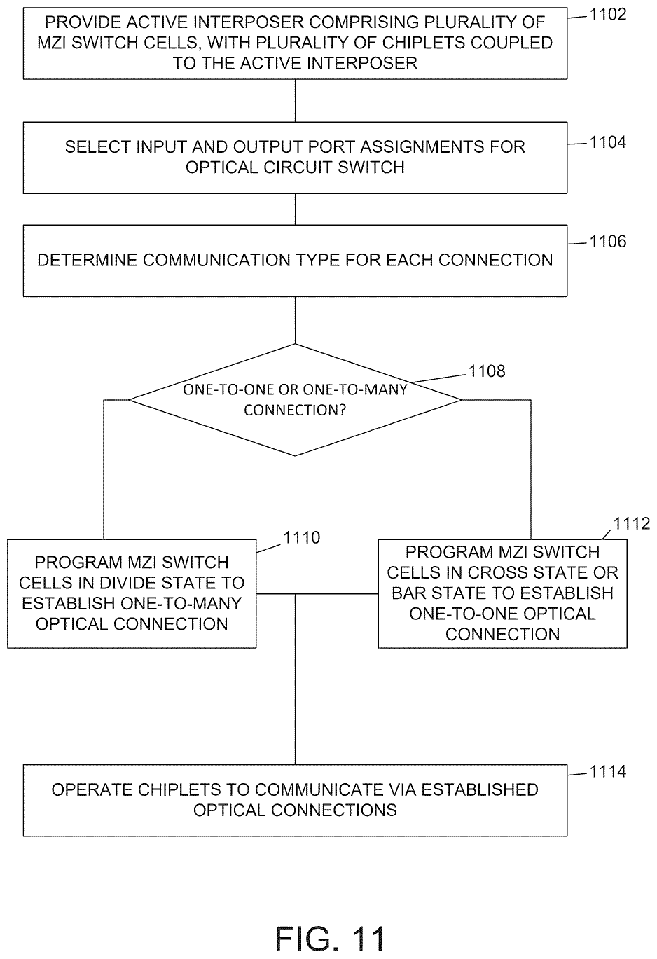

Referring to FIG. 9C, Algorithm 3 describes an example unicast and broadcast network management procedure for the memory-to-MAC and MAC-to-memory networks. In some embodiments, Algorithm 3 may determine whether each communication task requires a one-to-one or one-to-many connectivity pattern. For one-to-many tasks, the algorithm may adjust the laser source power for broadcast distribution, configures the MZI switch cells along the broadcast path to the divide state, and configures the input splitter cell accordingly. For one-to-one tasks, the algorithm may retrieve the precomputed unicast switch configuration from the configuration table and programs the relevant cells to cross or bar states. All MZI switch cells may then be programmed simultaneously via the control circuitry 124. Referring to FIG. 11, this procedure corresponds to the connection-type determination step and blocks 1110 and 1112 of the method described below.

In some embodiments, partial broadcast to a subset of destination chiplets is implemented by configuring a subset of the divide-state cells while leaving remaining cells in cross or bar states.

The following paragraphs describe an example implementation of the system 100 in which the interposer 102 may be a passive photonic interposer, that is, an interposer whose waveguides provide passive optical routing without active switching or modulation on the substrate, and the optical circuit switch 112 is implemented as a separate switch chiplet coupled to the passive interposer via optical vertical links (OVLs). Features of this implementation may include, for example, a passive interposer platform enabling modular chiplet integration with improved fabrication yield, redundant OVL interfaces with probabilistic loss modeling for misalignment tolerance, per-chiplet in-situ OVL characterization and loss-based subset selection, dynamic online OVL bandwidth steering, and a greedy bandwidth allocation algorithm for traffic-demand-driven circuit assignment.

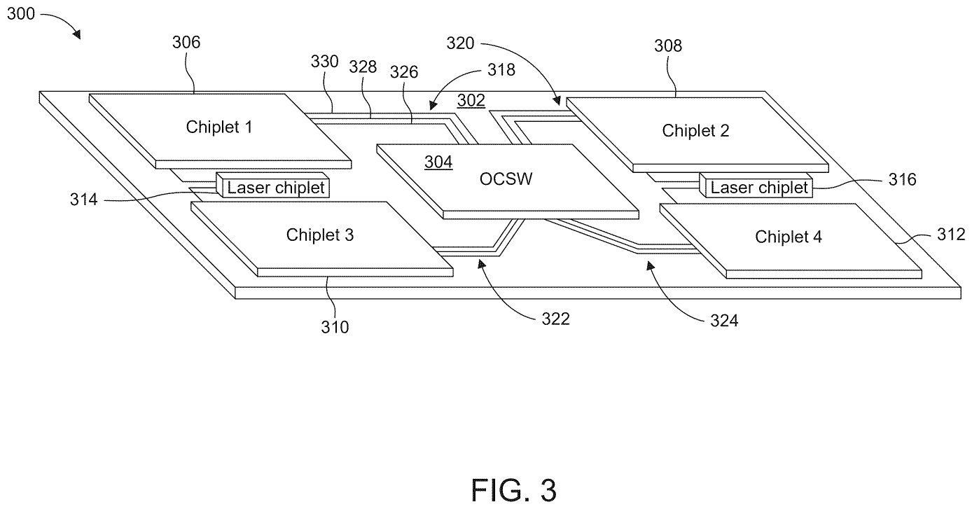

Referring to FIG. 3, an embodiment of a passive interposer system 300 is shown. The system 300 is an embodiment of the system 100 of FIG. 1 in which the interposer is a passive photonic interposer 302 and the optical circuit switch is a switch chiplet 304 coupled to the passive interposer 302 via optical vertical links (OVLs). In some embodiments, the chiplets coupled to the passive photonic interposer 302 may include three-dimensional photonic chiplets comprising stacked photonic integrated circuit layers, which are coupled vertically to the passive interposer 302 via OVL interfaces, implementing a 5.5D integration configuration.

In some embodiments, the passive photonic interposer 302 may be a substrate carrying passive waveguides that route optical signals between chiplets and the switch chiplet without active switching or modulation on the substrate. By keeping all active photonic components, including modulators and photodetectors, with their associated chiplets rather than on the interposer, the interposer 302 may serve as a passive routing layer. The passive photonic interposer might not integrate active photonic components such as the optical circuit switch, modulators, or photodetectors on the interposer substrate. By contrast, the active interposer embodiment described above integrates such active photonic components on the interposer substrate. This approach may simplify the interposer architecture, relax fabrication constraints, and enable the interposer to scale to larger sizes without yield concerns associated with active photonic components. In some embodiments, the passive waveguides of the interposer 302 exhibit a wavelength-dependent propagation loss that increases under dense wavelength division multiplexing conditions. A wavelength-dependent scaling factor may be applied to the waveguide loss model to account for higher propagation penalties as the number of wavelengths per link increases, ensuring that the system power budget accounts for the additional loss incurred at higher WDM channel counts. Passive waveguide platforms suitable for the interposer 302 include, but are not limited to, silicon nitride waveguides on a CMOS-compatible substrate and other low-loss dielectric waveguide platforms compatible with the optical coupling and wavelength-selective filtering requirements of the system.

In some embodiments, the switch chiplet 304 may implement the optical circuit switch function for the system 300. The switch chiplet 304 may be a photonic switch die coupled to the passive interposer 302 via OVL interfaces, configured to function as an optical circuit switch that may establish physical, end-to-end light paths between a source and a destination chiplet. Once a path is configured by the control circuitry 124, data may flow at the full optical bandwidth with minimal latency, for example because there may be no packet-level store-and-forward routing within the switch chiplet itself. Switch architectures suitable for implementation in the switch chiplet 304 include, but are not limited to, crossbar switch arrays, Benes switch networks, Clos topologies, PILOSS networks, and other N×N photonic switch topologies.

In some embodiments, the chiplets 306, 308, 310, 312 may be coupled to the passive interposer 302 via OVL interfaces and may communicate with each other through the switch chiplet 304 and the passive interposer waveguides. Each chiplet may include, for example, optical transceiver circuitry comprising a transmitter (Tx) bank housing modulators and a receiver (Rx) bank housing filters for WDM channel selection, together with a plurality of OVL interfaces and an on-chiplet reconfigurable optical switch for OVL subset selection, as described in FIGS. 8A through 8D and 9F.

In some embodiments, the first laser chiplet 314 and the second laser chiplet 316 may be optical sources coupled to the passive interposer 302 that provide continuous-wave (CW) optical carriers for the system. For example, an external or integrated laser source may provide CW light that is coupled onto the interposer 302 and distributed across the passive routing layer via low-loss waveguides. Each chiplet may integrate its own self-contained Tx and Rx banks, keeping all active optical components at the chiplet endpoints for a fully passive interposer.

In some embodiments, the passive interposer 302 may include a first waveguide channel 318 with redundant waveguide links, a second waveguide channel 320 with redundant waveguide links, a third waveguide channel 322 with redundant waveguide links, and a fourth waveguide channel 324 with redundant waveguide links, each coupling a respective chiplet to the switch chiplet 304 via OVL interfaces. In some embodiments, the first waveguide channel 318 may include a first waveguide 326, a second waveguide 328, and a third waveguide 330, providing redundant optical paths between a chiplet and the switch chiplet 304.

In some implementations, the passive interposer system 300 may include two distinct layers of optical switching. The first layer may be the system-level optical circuit switch implemented in the switch chiplet 304, which may route optical signals among chiplets across the interposer. The second layer may comprise smaller per-chiplet reconfigurable optical switches (e.g., reconfigurable optical switches 816, 828 of FIG. 8), one integrated within each chiplet, which select among the chiplet's redundant OVL interfaces. These two switch layers may serve independent functions and may operate independently of each other.

In some implementations, an optical signal from a source chiplet (e.g., chiplet 306) may travel vertically through an OVL interface to the passive interposer waveguides, may be routed along the passive waveguides to the switch chiplet 304, may be routed by the switch chiplet to the appropriate output waveguide according to the programmed connectivity configuration, may be routed along the passive waveguides to the destination chiplet's OVL interface, and may be received by the destination chiplet. The connectivity configuration may be programmed by the control circuitry 124 and may persist until it is reprogrammed.

In some embodiments, the total optical path loss through the passive interposer system 300 is characterized as the aggregate of individual component losses along the optical path. For a given source-to-destination optical path, the total insertion loss comprises contributions from the modulator of the source chiplet, the optical vertical link interfaces traversed in each direction between chiplets and the interposer, the passive waveguide propagation loss, the switching loss through the switch chiplet 304, and the filter loss at the destination chiplet. In some embodiments, the total path loss L_tot for a given optical path can be expressed as L_tot=L_mod+Σ(2·L_VL, i)+L_WG+L_switch+L_filter, where L_mod is the modulator insertion loss, L_VL,i is the loss of the i-th optical vertical link interface, the factor of two accounts for traversal of an OVL interface in each of the upward and downward directions and reflects an approximately symmetric loss model used for analytical purposes; in practice, uplink and downlink coupling losses may differ due to coupler asymmetry, alignment bias, thermal effects, or wavelength-dependent effects, L_WG is the waveguide propagation loss, L_switch is the aggregate switching loss through the switch chiplet 304, and L_filter is the filter insertion loss at the destination chiplet. The minimum optical launch power required to maintain adequate received power at the destination chiplet's photodetector is determined by the total path loss and the photodetector sensitivity, and can be expressed as P_launch=10\hat{ }((L_tot+|P_sens|)/10), where P_sens is the photodetector sensitivity in dBm. This relationship governs the laser source power budget for the system and informs the selection of switch topology, OVL redundancy factor, and waveguide routing to minimize total path loss.

Some embodiments of the described technology in which the interposer is a passive photonic interposer have many advantages, including, but not limited to, independent sourcing, testing, known-good-die selection, and assembly of the switch chiplet and functional chiplets, improving modularity and enabling chiplet-level yield optimization. The passive interposer platform also supports a 5.5D integration concept in which photonic chiplets are stacked vertically above the passive photonic interposer via OVL interfaces, adding a vertical dimension to a conventional 2.5D side-by-side chiplet arrangement. It is not necessary for every embodiment of the described technology to incorporate all of these advantages, and some embodiments may exhibit none of them.

The switch chiplet 304 can implement any of a variety of switching network topologies, depending on the system's requirements for port count, insertion loss, fabrication area, and loss uniformity. Four candidate topologies are described below; additional topologies are also contemplated.

Crossbar: In some embodiments, the crossbar topology may provide strictly non-blocking connectivity in which every input port can connect directly to any output port without internal conflicts and without waveguide crossings within the switching fabric. The number of switching cells may grow quadratically with port count (O(N²)), which may be impractical for large port counts but may be suitable for compact, low-loss implementations at smaller scales.

Clos: In some embodiments, the Clos topology may reduce the number of required switching cells relative to the crossbar by organizing the switch into multiple smaller sub-switch stages. However, the Clos structure may introduce significant inter-stage waveguide crossings, which may contribute additional insertion loss at each crossing.

Benes: In some embodiments, the Benes network may achieve rearrangeably non-blocking connectivity while scaling the number of switching cells as O(N log N), enabling larger port counts with far fewer cells than Crossbar or Clos, making it potentially attractive for compact interposer applications. The Benes network employed in some embodiments uses a stage count given by S=2·log₂(N_port)−1 stages, where N_port denotes the total port count of the switch fabric, yielding O(N log N) scaling of the number of switching cells and favorable insertion loss scaling relative to the Crossbar at larger port counts.

PILOSS: In some embodiments, the PILOSS topology may be particularly well suited for electro-optic (EO) switch implementations where phase shifters introduce state-dependent losses. In a PILOSS network, exactly one MZI switch cell may be active for any given input-output connection, resulting in highly uniform insertion loss across all paths. While PILOSS requires more total switching cells than Benes, its loss uniformity and predictable performance may be advantageous for EO switching fabrics where power consumption and insertion loss depend strongly on the number of active phase shifters.

In some embodiments, the Benes network may be suitable for the switch chiplet 304 where compactness, scalability, and full connectivity are needed without the resource overhead of a full crossbar. In other embodiments, PILOSS provides an attractive alternative when insertion loss uniformity is the primary optimization target.

Referring to FIG. 9D, Algorithm 4 describes an example loss-aware routing procedure for the switch chiplet 304. In some embodiments, Algorithm 4 may use a recursive backtracking approach that systematically explores routing paths through the switch fabric stage by stage, prioritizing configurations that maximize the use of bar-state switch cells, which in typical electro-optic implementations exhibit lower insertion loss and lower power consumption than cross-state cells, while maintaining non-blocking connectivity for the required input-to-output mapping. For connectivity patterns that are encountered frequently, precomputed switch configurations are stored in a lookup table enabling O(1) runtime retrieval for those patterns, avoiding the need for runtime backtracking computation. The recursive backtracking algorithm has a worst-case computational complexity of O(2\hat{ }(N/2)·log N), where N may be the port count of the switch fabric, reflecting the exhaustive exploration of valid routing paths at each recursive level. By contrast, conventional looping-based Benes routing algorithms exhibit O(N log N) complexity but do not account for state-dependent loss differences. The precomputed lookup table approach amortizes the higher computational cost of the backtracking algorithm by performing the computation offline and storing the results for O(1) retrieval at runtime. By maximizing bar-state assignments, the total switching power is reduced compared to routing algorithms that do not account for the loss and power difference between switch states.

Referring to FIG. 9E, Algorithm 5 describes an example perfect-shuffle interconnection pattern applied between stages of the Benes switch fabric in the switch chiplet 304. In some embodiments, Algorithm 5 may implement the stage-to-stage signal path rearrangement required by the Benes network structure. At each stage boundary, signal paths may be permuted according to a perfect-shuffle pattern to ensure that the stage-by-stage recursion of the Benes routing algorithm produces valid non-blocking configurations. The perfect-shuffle interconnection pattern reorders the signals between stages by interleaving even-indexed and odd-indexed elements of the signal array. For an input array of length N, the shuffled output at position i is given by the element at index ((i mod 2)·N/2+└i/2┘) of the input array, for i ranging from 0 to N−1. This deterministic reordering may ensure that the recursive decomposition of the Benes network into smaller sub-networks preserves the correct signal path assignments at each stage boundary.

Referring to FIG. 7A, the passive photonic interposer system 300 is shown in a unicast configuration. Referring to FIG. 7B, the system 300 is shown in a broadcast configuration. In some embodiments, the system may include writer chiplet 702, switch chiplet 704, reader chiplets 706 and 708, laser bank 710, passive photonic interposer 712, and a plurality of OVLs 722 comprising individual OVL links 724, 726, 728, 730, 732, 734, and 736. The passive photonic interposer 712 may include interposer waveguides 714, 716, 718, and 720 routing optical signals between chiplets and the switch chiplet 704. The writer chiplet 702 may include a serializer 738, a buffer 740, microring resonator couplers 742, 744, 748, and 750, multi-wavelength waveguides 746 and 752, and a multiplexer 754 producing an output waveguide 756. The switch chiplet 704 may include controller/scheduler circuitry 760, optical drive circuitry 762, and photonic optical switch circuitry 764 receiving an input waveguide 758 and producing output waveguides 766 and 768. Each reader chiplet (for example, reader chiplet 706) may include a deserializer 770, an output read buffer 772, multiplexers 774 and 780, waveguides 776 and 778, and tunable microring resonators 782 and 784. Reader chiplet 708 may include tunable microring resonators 786 and 788, a deserializer 790, and an output read buffer 792.

The system 300 of FIG. 7A further includes a passive photonic interposer system 700 in which the passive photonic interposer 712 routes optical signals between chiplets and the switch chiplet via interposer waveguides. In the configuration of FIG. 7A, the switch chiplet 704 implements a wavelength-selective switch configuration in which OVLs are shared among chiplets using a broadband multiplexer, and the switch separates wavelengths and routes them to the appropriate destination chiplets accordingly. In the configuration of FIG. 7B, the switch chiplet 704 implements a broadband optical switch configuration in which multiple chiplets are interconnected via broadband switching elements within the N×N switch fabric, enabling multiple wavelengths to be switched together as a group, providing higher aggregate bandwidth at the cost of increased OVL usage.

In some implementations, the OVLs 722 may include optical coupling structures that couple optical signals between a chiplet and the passive interposer 712 in a direction perpendicular or substantially perpendicular to the plane of the interposer, providing direct vertical optical connectivity between chiplets and the interposer without requiring lateral edge coupling. Technologies suitable for implementing OVL interfaces include, but are not limited to, grating coupler arrays, micro-lens arrays, meta-grating couplers, 3D nanoprinted free-form couplers, and photonic wire bonds. The OVL redundancy architecture and subset selection protocol described below with reference to FIGS. 8A through 8D and 9F are agnostic to the specific OVL coupler technology, provided the links fall within the modeled loss envelope.

In the unicast configuration of FIG. 7A, in some embodiments, the switch chiplet 704 employs wavelength-selective switching in which the writer chiplet 702 transmits data on specific wavelengths, and the wavelength-selective switch separates and routes each wavelength to the appropriate destination reader chiplet—for example, reader chiplet 706—through the passive interposer waveguides and OVL interfaces, while reader chiplet 708 may not receive the signal in this configuration.

In the broadcast configuration of FIG. 7B, in some embodiments, the switch chiplet 704 employs broadband switching elements within the N×N switch fabric, enabling multiple wavelengths to be switched together as a group, and may be programmed to route an optical signal from the writer chiplet 702 to both reader chiplets 706 and 708 simultaneously through the passive interposer waveguides and OVL interfaces, providing higher aggregate bandwidth at the cost of increased OVL usage.

In some embodiments, the switch chiplet 704 can be programmed to implement partial broadcast to a subset of reader chiplets, multi-path routing, or other connectivity patterns beyond the unicast and full-broadcast examples illustrated in FIGS. 7A and 7B.

The passive interposer system 300 includes, in some embodiments, bandwidth allocation circuitry configured to determine a traffic demand for each of a plurality of pairs of chiplets and to allocate circuit-switched optical connections accordingly. The bandwidth allocation circuitry monitors inter-chiplet communication requirements (e.g., by tracking the volumes of data that different chiplet pairs need to exchange) and dynamically allocates circuit-switched optical connections to serve the highest-demand pairs first.

Unlike a static bus or fixed point-to-point links, in some embodiments, the reconfigurable switch chiplet 304 may allow the interconnect to adapt to the varying communication patterns of different applications, or even different phases within a single application. Bandwidth may be steered dynamically, for example creating high-bandwidth optical channels between chiplets that need to exchange large volumes of data, including by utilizing multiple OVLs to increase the available optical bandwidth between chiplet pairs, and then reconfiguring those channels to serve other communication demands as requirements change.

Technologies suitable for implementing bandwidth allocation circuitry include, but are not limited to, hardware accelerators, embedded processors executing firmware, and software modules executing on a processor accessible to the control circuitry, photonic logic circuits, photonic processing elements, or hybrid electro-photonic circuitry in which one or more bandwidth allocation functions are implemented using photonic computing components.

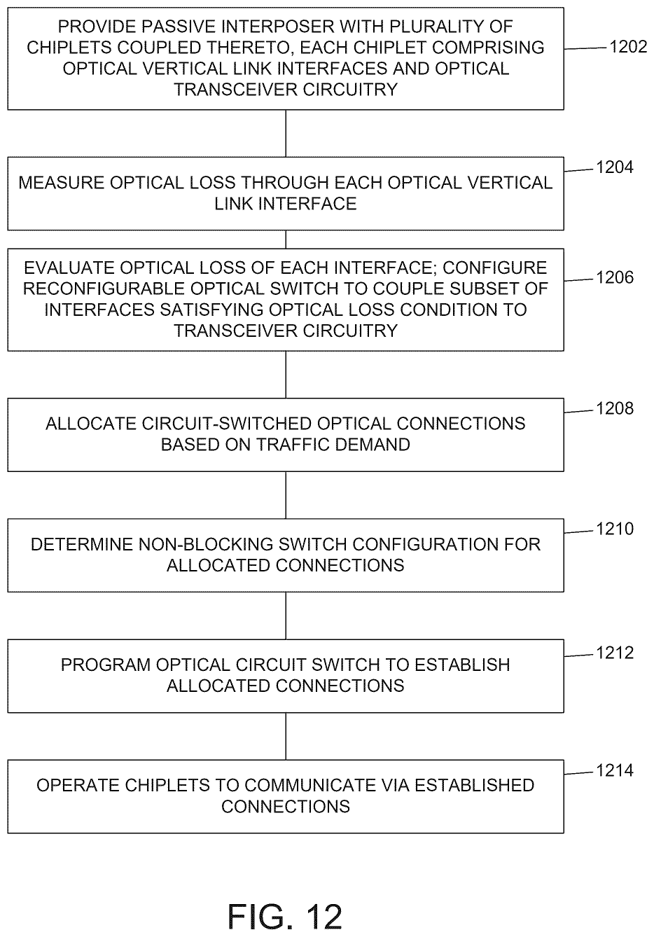

Referring to FIG. 9G, Algorithm 7 describes an example greedy bandwidth allocation procedure. In some embodiments, Algorithm 7 may take as inputs the data volume V for a given communication flow (in Gb), the bandwidth per allocated lane B (in Gbps), the maximum number of available lanes L, and a volume-per-lane step parameter S (in Gb) that defines the volume threshold per lane. The algorithm may compute the number of lanes needed as the ceiling of V divided by S, clamps the result to the range [1, L], and returns the allocated number of lanes. At the system level, this per-flow computation is applied iteratively across all chiplet pairs in decreasing order of traffic demand. The highest-demand pair may be allocated its lanes first, then the next-highest-demand pair may be allocated from the remaining switch resources, and this process continues until all available switch resources are allocated or all remaining pairs' demands fall below the per-lane threshold. The switch chiplet 304 may then be programmed by the control circuitry according to the resulting allocation. Referring to FIG. 12, this allocation procedure corresponds to blocks 1204 through 1210 of the method described below.

In some embodiments the greedy allocation improves system throughput for workloads with skewed traffic distributions by concentrating switch resources on the highest-demand chiplet pairs. Alternative bandwidth allocation approaches suitable for other embodiments include, but are not limited to, round-robin allocation, priority-queue-based allocation, and integer linear programming formulations.

In some implementations, the performance of OVLs may be sensitive to the mechanical precision of the chiplet-to-interposer assembly process. During packaging, process variations may introduce physical misalignments between the chiplet's OVL interfaces and the interposer's corresponding waveguide or coupler structures. These misalignments (which may include lateral (x-y) shifts, vertical (z) gaps, or angular tilts) may increase the optical loss at the affected OVL interface. Misalignment may cause mode distortion and optical loss, potentially reducing the optical signal quality at the receiving chiplet. In addition to such static packaging-induced misalignments, runtime thermal variations, aging effects, and other dynamic environmental changes may also degrade OVL coupling efficiency over time, producing similar elevations in optical loss at affected OVL interfaces.

To address this challenge, in some embodiments, each chiplet in the passive interposer system 300 may include a plurality of OVL interfaces, wherein the number of OVL interfaces N may be greater than, equal to, or, in wavelength-division multiplexed configurations in which multiple optical channels are carried on a single OVL, fewer than the number of active optical channels M required for the chiplet's transmitter and receiver banks. This surplus of physical OVL links may provide a redundancy pool from which a healthy subset may be selected, even if some OVL interfaces exhibit elevated optical loss due to packaging-induced misalignment or runtime thermal and aging variations or other fabrication variations.

In some embodiments implementing wavelength-division multiplexed (WDM) configurations, a single OVL interface carries a plurality of optical channels at distinct wavelengths simultaneously, such that the number of OVL interfaces N is fewer than the number of active optical channels M provided by the optical transceiver circuitry. In such configurations, a wavelength multiplexer integrated within the chiplet combines the plurality of optical channels onto a single OVL interface for transmission to the interposer, and a corresponding wavelength demultiplexer at the receiving end separates the individual wavelength channels from the shared OVL interface. Components suitable for implementing the wavelength multiplexer and demultiplexer include, but are not limited to, microring resonator filter banks, arrayed waveguide gratings (AWGs), echelle gratings, and cascaded Mach-Zehnder interferometer lattice filters. The WDM configuration may reduce the total number of physical OVL interfaces required per chiplet at the cost of increased on-chiplet multiplexing complexity. In some embodiments, the reconfigurable optical switch 816, 828 operates in conjunction with the wavelength multiplexer and demultiplexer to enable combined wavelength-domain and spatial-domain reconfigurability. The redundancy-based OVL subset selection protocol described herein applies to WDM configurations, with the on-chiplet circuitry characterizing and selecting OVL interfaces based on broadband or per-wavelength optical loss measurements.

Referring to FIGS. 8A through 8D, a system 800 illustrating the per-chiplet redundant OVL architecture is shown. In some embodiments, each chiplet (e.g., a first chiplet 802 and a second chiplet 804) may be coupled to a passive photonic interposer 806 via a plurality of OVL interfaces 810, 820. The first chiplet 802 may include an EIC serializer 812, a PIC Tx bank 814, and a reconfigurable optical switch 816 that cross-connects the internal Tx/Rx banks to a selectable subset of the chiplet's physical OVL interfaces. The second chiplet 804 may include an EIC deserializer 824, a PIC Rx bank 826, and a reconfigurable optical switch 828 that cross-connects the internal Tx/Rx banks to a selectable subset of that chiplet's physical OVL interfaces. Connectors 818 such as microbumps may couple the EIC serializer 812 to the PIC Tx bank 814. A laser 808 may provide optical carriers via an input laser waveguide 822 to the PIC Tx bank 814. In some embodiments, the electronic and photonic circuit layers of a chiplet—for example, the EIC serializer 812 and the PIC Tx bank 814 of the first chiplet 802, or the EIC deserializer 824 and the PIC Rx bank 826 of the second chiplet 804—may be co-fabricated on a single monolithically integrated electro-photonic die.

In some implementations, the reconfigurable optical switch 816, 828 may include a photonic switching element integrated within the respective chiplet, distinct from the system-level optical circuit switch in the switch chiplet 304, that selects which OVL interfaces are coupled to the optical transceiver circuitry during operation. The reconfigurable optical switch 816, 828 acts as a local cross-connect between the M functional transmit and receive lanes and the larger pool of N physical OVL interfaces, enabling flexible lane-to-OVL mappings.

Referring to FIG. 8C, in some embodiments the reconfigurable optical switch 816, 828 is implemented as a Benes network 858 configured to provide flexible cross-connect routing between M Tx/Rx banks and N OVL interfaces. Referring to FIG. 8D, in other embodiments the reconfigurable optical switch 816, 828 is implemented as a tree-based switch 860, in which a binary tree structure progressively routes each Tx/Rx bank to a selected OVL interface, minimizing the number of active switching elements and thereby minimizing insertion loss within the chiplet for the common case of selecting a single OVL per Tx/Rx bank. The tree-based switch 860 is one implementation example for the per-chiplet reconfigurable switch in some embodiments.

Switch architectures suitable for the reconfigurable optical switch 816, 828 include, but are not limited to, Benes-network configurations, tree-based configurations, and other compact photonic cross-connect topologies. The reconfigurable optical switch 816, 828 is explicitly distinguished from the system-level switch chiplet 304: the reconfigurable optical switch 816, 828 operates within a single chiplet to select among that chiplet's N physical OVL interfaces, while the switch chiplet 304 routes optical signals between different chiplets across the passive interposer 302.

The redundant OVL architecture is modeled probabilistically to determine the appropriate redundancy factor N/M. Referring to FIG. 8B, the OVL misalignment detail illustrates the effects of packaging-induced misalignment on individual OVL interfaces. A chiplet side 830 and a passive silicon interposer side 832 are shown with a plurality of vias and OVL interfaces. A via 834 aligned with an OVL interface 836 provides low-loss coupling. A via 838 misaligned with the OVL interface 836 results in elevated optical loss, disqualifying that interface. Additional vias 840, 844, 846, 850, and 852 and OVL interfaces 842, 848, 854, and 856 illustrate varying degrees of alignment and misalignment, with well-aligned interfaces such as OVL 848 aligned with vias 846 and 850 being selected for active use, and misaligned interfaces such as OVL 842 and OVL 854 being disqualified. The optical loss of any given OVL interface is drawn from a mixture of two distributions: a nominal loss distribution capturing typical process variations, in one embodiment modeled with a mean of approximately 1.5 dB and a standard deviation of approximately 1.2 dB, and in another embodiment modeled with a mean of approximately 1.0 dB anchored to measured vertical link data; and an anomalous-event distribution capturing rare, high-impact packaging failures such as particle contamination or severe misalignment, in one embodiment modeled with a mean of approximately 10.0 dB and a probability of occurrence of approximately 10%, and in another embodiment modeled with a mean of approximately 3.0 dB and a probability of occurrence of approximately 5%, these two parameter sets representing distinct simulation configurations and not a single continuous range. In some embodiments, the mixture distribution further includes a minimum physical loss floor L_min, below which no OVL interface loss can fall, reflecting the intrinsic minimum coupling loss of the vertical optical coupling structure regardless of alignment quality. Additionally, in some embodiments, the nominal branch of the mixture distribution incorporates a correlation parameter ρ∈[0, 1] across the OVL interfaces of a given chiplet-to-interposer interface, wherein ρ=0 represents fully independent per-link loss realizations and larger values of ρ introduce proportional co-variation among the OVL interfaces of that interface to model lithography-driven common-mode placement errors, without changing the per-link mean or variance or the anomalous-event branch of the distribution. The correlation parameter ρ affects the benefit of redundancy-based OVL selection: higher correlation (larger ρ) can increase the benefit of best-of-N selection when the common-mode error shifts all links in the same direction, while lower correlation provides greater diversity among the redundant links. Such values are provided by way of example and are not limiting. With only a single OVL interface per active channel and no redundancy, system reachability under modeled conditions is approximately 77%. By introducing redundant OVL interfaces and the selection protocol described below, system reachability reaches approximately 100% at a redundancy factor of approximately six, which value is also provided by way of example and is not limiting.

Some embodiments of the described technology implementing per-chiplet redundant OVL interfaces have many advantages, including, but not limited to, improved system reliability and yield by tolerating packaging-induced misalignment and fabrication variation in OVL coupling structures, as well as runtime thermal variations and aging effects that may dynamically alter OVL coupling efficiency, without requiring perfect alignment of every interface. Each chiplet selects its active OVL subset independently, without requiring inter-chiplet coordination, so that subset selection can proceed in parallel across all chiplets simultaneously. It is not necessary for every embodiment of the described technology to incorporate all of these advantages, and some embodiments may exhibit none of them.

In some embodiments, the effective optical loss of a chiplet's OVL interface, after application of the redundancy-based subset selection, is determined by selecting the minimum-loss interface from the pool of N available OVL interfaces. For a chiplet having R redundant OVL interfaces available for a given active optical channel, the effective OVL loss L_VL,eff is given by L_VL,eff=min{L_VL\hat{ }(1), L_VL\hat{ }(2), . . . , L_VL\hat{ }(R)}, where L_VL\hat{ }(j) denotes the measured optical loss of the j-th OVL interface in the redundant pool. This best-of-R selection rule ensures that the system routes each active optical channel through the lowest-loss available physical link, thereby minimizing the contribution of OVL coupling loss to the total optical path loss and reducing the required laser launch power.

To leverage the redundant OVL interface pool, in some embodiments, the on-chiplet circuitry may execute an in-situ characterization protocol that measures the optical loss through each of the N OVL interfaces and may build a loss-ranked lookup table of OVL quality. The on-chiplet circuitry may then configure the reconfigurable optical switch 816, 828 to couple the optical transceiver circuitry to the M OVL interfaces satisfying an optical loss condition, for example the M interfaces with the lowest measured optical loss. In some embodiments, the loss measurements and the resulting lookup table may be dynamically updated during operation by re-executing the characterization protocol, for example during scheduled calibration phases conducted under multiple operating conditions, to account for runtime thermal variations, aging effects, or changes in the chiplet-to-interposer coupling environment.

In some implementations, the optical loss condition may include a condition based on measured or estimated optical loss through OVL interfaces, applied to select a subset of the N interfaces for active use. Optical loss conditions suitable for subset selection include, but are not limited to: rank-based selection, in which the M lowest-loss interfaces are selected; threshold-based selection, in which all interfaces having a measured loss below a specified threshold are selected; tolerance-band selection, in which interfaces within a specified loss range are selected; and weighted or probabilistic selection criteria.

Referring to FIG. 9F, Algorithm 6 describes an example in-situ OVL characterization and subset selection procedure. In some embodiments, Algorithm 6 may take as inputs the number of OVL interfaces N and the known input test signal power. For each OVL interface i from 0 to N minus 1, the algorithm may activate interface i via the reconfigurable optical switch 816, 828, transmit a test signal through interface i, measure the received power at the far end, and compute the optical loss in dB, recording the interface index and loss value in an OVL quality list. After all N interfaces have been characterized, the algorithm may sort the OVL quality list in ascending order of loss to produce a lookup table of OVL quality ranked from best to worst. The algorithm may then configure the reconfigurable optical switch 816, 828 to couple the M transmit and receive banks to the top M entries in the lookup table, that is, the M lowest-loss interfaces, thereby completing the subset selection. This process may build a complete picture of the relative optical quality of every available OVL interface, allowing the system to route all traffic through the healthiest available links. The characterization protocol may be implemented using one or more test-path configurations, including but not limited to: loopback paths in which a test signal is transmitted through an OVL interface and returned to the originating chiplet via a loopback structure on the interposer or at the switch chiplet; temporary switch configurations in which the switch chiplet is programmed to route a test signal from the characterizing chiplet's OVL interface to a known reference detector; and dedicated test photodiodes integrated at the interposer-side termination of each OVL interface to provide local loss measurement without requiring end-to-end system routing. The specific test-path implementation may be selected based on the system architecture and the availability of loopback or reference structures. In some embodiments, the loss-ranked lookup table produced by Algorithm 6 may further be used to assign the lowest-loss OVL interfaces to the most latency-sensitive or highest-priority optical channels, while assigning higher-loss interfaces to less critical traffic, enabling quality-of-service differentiation among optical channels within a single chiplet.

In some embodiments, each chiplet may execute Algorithm 6 independently and in parallel with the other chiplets, without requiring inter-chiplet coordination. Referring to FIG. 12, the characterization and subset selection steps correspond to blocks 1204 through 1208 of the method described below.

In some embodiments, the in-situ characterization protocol can be re-executed during operation to update loss measurements and re-select the active OVL subset in response to changing conditions. The control circuitry 124 monitors the quality of active OVL links during operation. When the quality of one or more active links degrades, for example due to thermal variation causing mechanical drift at the chiplet-to-interposer interface or due to aging of the coupling structure, the on-chiplet circuitry re-runs Algorithm 6 to re-rank the available OVL interfaces and reconfigure the reconfigurable optical switch 816, 828 to the new optimal subset. In some embodiments, calibration phases are run under multiple temperature conditions to build a thermally-indexed LUT that accounts for runtime thermal variation. Re-characterization can be triggered by a control signal from the system-level control circuitry 124, by a periodic timer, or autonomously by on-chiplet circuitry detecting degraded link performance as measured, for example, by elevated bit error rates or reduced received optical power on an active link.

In some embodiments, the reconfigurable optical switch 816, 828 supports online expansion of the active OVL subset (i.e., the number of OVL interfaces actively coupled to the optical transceiver circuitry can be increased beyond the baseline selected subset), responsive to a control signal indicating that additional optical bandwidth is needed.

The reconfigurable optical switch 816, 828 can, in some embodiments, couple more than the baseline M active Tx/Rx lanes to OVL interfaces simultaneously, allowing two or more OVL links to carry traffic for the same Tx/Rx bank concurrently and thereby increasing the available optical bandwidth for that chiplet. This online bandwidth steering capability enables the interconnect to dynamically adapt to increased communication demands without requiring a full system reconfiguration or re-execution of the characterization protocol of Section IV.F.

In some embodiments, the control signal that triggers subset expansion may originate from a variety of sources. Sources suitable for generating the control signal include, but are not limited to: the system-level control circuitry 124 directing increased bandwidth allocation to a particular chiplet; the bandwidth allocation circuitry described above with reference to FIG. 9G indicating a demand increase for a chiplet pair that would benefit from additional OVL capacity; or an autonomous determination by the on-chiplet circuitry that available OVL bandwidth is insufficient for pending data transfers, detected for example by monitoring transmit buffer occupancy or link utilization metrics.

In some implementations, the subset expansion may be distinguished from the initial characterization and subset selection described with reference to FIG. 9F: expansion may add already-characterized OVL interfaces (those whose loss characteristics are already recorded in the LUT) to the active subset without requiring a new full characterization cycle. The reconfigurable optical switch 816, 828 may be reconfigured to route additional Tx/Rx lanes to the next-ranked OVL interfaces in the LUT, using the previously computed loss rankings to select the best available additional links.

Some embodiments implementing online OVL subset expansion have many advantages, including, but not limited to, the ability to dynamically steer bandwidth toward chiplet pairs with high instantaneous demand (creating additional optical capacity precisely where and when it is needed) without incurring the latency or overhead of a full system reconfiguration. It is not necessary for every embodiment of the described technology to incorporate all of these advantages, and some embodiments may exhibit none of them.

Referring to FIG. 10, an embodiment of a method 1000 of operating a photonic chiplet system is shown.

The method 1000 commences with a photonic chiplet system in an initial state in which a plurality of chiplets are coupled to an interposer via optical ports and waveguides, an optical circuit switch is coupled to the waveguides, and control circuitry is accessible to program the optical circuit switch.

At block 1004, the control circuitry programs the optical circuit switch to set a connectivity configuration. The control circuitry sets the switch states of the individual switching elements that comprise the optical circuit switch, thereby determining which input-to-output paths are established through the switch.

At block 1006, one or more circuit-switched optical connections are established between chiplets of the plurality of chiplets through the interposer waveguides according to the programmed connectivity configuration.

At block 1008, with the circuit-switched optical connections established, the chiplets exchange data optically through the persistent connectivity configuration. The configuration persists until the control circuitry reprograms the optical circuit switch to a new configuration.

At decision block 1010, the control circuitry determines whether a new connectivity configuration is needed, for example because workload communication patterns have changed. If reconfiguration is needed, the method proceeds to block 1012. Otherwise, the method proceeds to block 1014.

At block 1012, the control circuitry reprograms the optical circuit switch to a new connectivity configuration responsive to the changed communication requirements. The method then returns to block 1006, where new circuit-switched optical connections are established according to the new configuration.

At block 1014, if no reconfiguration is needed and the current operating session ends, the method terminates.

In some embodiments, block 1006 is implemented by receiving a circuit-configuration command specifying a desired connectivity pattern, retrieving a precomputed switch configuration from a configuration table stored in memory accessible to the control circuitry, and applying the retrieved configuration to program the optical circuit switch. This retrieval-and-application implementation corresponds to the precomputed configuration approach described above.

Referring to FIG. 11, an embodiment of a method 1100 of operating a photonic chiplet system including an active silicon photonic interposer is shown. The method 1100 is an embodiment of the method 1000 of FIG. 10 that includes steps specific to implementations in which the interposer is an active silicon photonic interposer, as described with reference to FIGS. 2, 4A, 4B, 5A through 5F, and 6A through 6B.

At block 1102, the system is provided with an active silicon photonic interposer that integrates waveguides and an MZI-based optical circuit switch on a silicon photonic substrate.

At block 1104, the control circuitry assigns chiplets to switch input ports and output ports using the input selection and output selection procedures of Algorithms 1 and 2 (FIGS. 9A and 9B) described above with reference to FIGS. 5A through 5E.

At block 1106, the control circuitry determines, for each communication task, whether a one-to-one or one-to-many connectivity pattern is required.

At decision block 1108, the control circuitry evaluates whether the connection type is one-to-many, such as broadcast or multicast. If the connection type is one-to-many, the method proceeds to block 1112. If the connection type is not one-to-many, the method proceeds to block 1110.

At block 1110, for one-to-one connectivity, the control circuitry programs the relevant MZI switch cells to cross or bar states to establish unicast circuit-switched connections.

At block 1112, for one-to-many connectivity, the control circuitry programs the relevant MZI switch cells to the divide state to establish broadcast or multicast circuit-switched connections, and adjusts laser power for the broadcast tree distribution, following Algorithm 3 (FIG. 9C) described above with reference to FIG. 5F.

At block 1114, the chiplets exchange data optically through the programmed connectivity configuration. The method corresponds to block 1008 of FIG. 10, and the reconfiguration loop of blocks 1010 and 1012 of FIG. 10 applies analogously.

Referring to FIG. 12, an embodiment of a method 1200 of operating a photonic chiplet system including a passive photonic interposer is shown.

At block 1202, the system is provided with a passive interposer having a plurality of chiplets coupled thereto, each chiplet comprising optical vertical link interfaces and optical transceiver circuitry. The system is initialized with the passive interposer and chiplets in an operational state.

At block 1204, the on-chiplet circuitry of each chiplet measures optical loss through each of the chiplet's plurality of OVL interfaces, following Algorithm 6 (FIG. 9F). At block 1206, the on-chiplet circuitry evaluates the loss measurements against the optical loss condition to rank and select the subset of OVL interfaces satisfying the optical loss condition, and configures the reconfigurable optical switch to couple the optical transceiver circuitry to the selected subset of OVL interfaces. This characterization and selection process is performed independently by each chiplet in parallel. At block 1208, the bandwidth allocation circuitry determines the traffic demand for each of a plurality of pairs of chiplets and iteratively allocates circuit-switched optical connections to chiplet pairs in order of decreasing traffic demand, following Algorithm 7 (FIG. 9G).

At block 1210, the control circuitry determines a non-blocking switch configuration for the connections allocated in block 1208, using the loss-aware routing procedure of Algorithm 4 (FIG. 9D) or a precomputed lookup table.

At block 1212, the control circuitry programs the switch chiplet (the optical circuit switch of the passive interposer system) according to the non-blocking switch configuration determined in block 1210.

At block 1214, the chiplets exchange data optically through the programmed connectivity configuration and the selected OVL subsets. The configuration persists until the control circuitry reprograms the switch chiplet or the on-chiplet switches reconfigure the OVL subsets.

In some embodiments, the method 1200 includes a step of monitoring the quality of active OVL links during operation and, responsive to detecting degraded link performance or changing conditions, re-executing the characterization steps of Algorithm 6 (FIG. 9F) to update loss measurements and re-select the active OVL subset. This re-characterization can be triggered by a control signal, a periodic timer, or autonomous on-chiplet detection.

This section describes embodiments of a non-transitory computer-readable medium storing a device design that encodes the photonic chiplet systems in the foregoing paragraphs, and describes how the encoded systems are fabricated from the stored design.

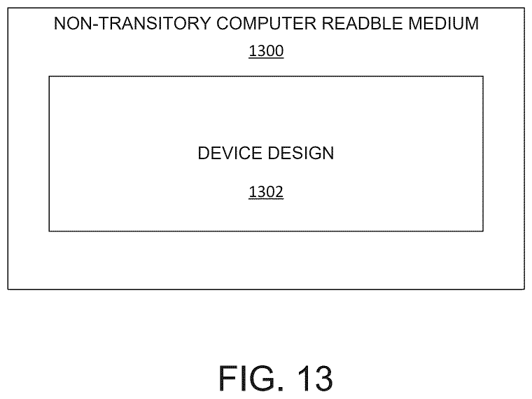

Referring to FIG. 13, an embodiment of a non-transitory computer-readable medium 1300 storing a device design 1302 is shown. The device design 1302 encodes a photonic chiplet system—including an interposer, a plurality of chiplets, an optical circuit switch, and control circuitry—in a machine-readable format suitable for photonic and electronic fabrication.

The device design 1302 includes schematic-level representations of the photonic circuits and electrical control logic, hardware description language representations of the control circuitry and other computer-implemented circuitry, and physical layout definitions compatible with fabrication data formats. Format types suitable for the device design 1302 include, but are not limited to, VHDL files, Verilog files, SystemVerilog files, GDSII files, OASIS files, netlists, and process design kit compatible layout data. As used herein, the term non-transitory computer-readable medium excludes transitory propagating signals and encompasses all forms of physical storage media including semiconductor memory, magnetic storage, optical storage, and other persistent storage technologies.

Where the interposer is a device design 1302 encodes a system in which the active silicon photonic interposer, the device design 1302 encodes the active silicon photonic interposer including the plurality of MZI switch cells. For each MZI switch cell, the design encodes: the first coupler (in some embodiments an inverse-designed MMI coupler having dimensions optimized for uniform 50/50 splitting across the C-band); the second coupler (in some embodiments an inverse-designed MMI coupler); the first arm coupled between the first coupler and the second coupler, including the doped phase-shifter region; the second arm coupled between the first coupler and the second coupler, including the doped phase-shifter region; and the driver circuit configured to apply a voltage or current to the phase-shifter regions to set the switch state. The design further encodes the waveguide geometries, switch cell placements, chiplet gateway interfaces, and other structural elements of the active interposer system 200 described in Section III. The design encoding is consistent with the descriptions in FIGS. 2, 4A, 4B, 5A through 5F, and 6A through 6B.

Where the device design 1302 encodes a system in which the interposer is a passive photonic interposer, the device design 1302 encodes the passive photonic interposer including the plurality of passive waveguides, the switch chiplet implementing the optical circuit switch, the plurality of OVL interfaces at each chiplet-to-interposer coupling location, the optical transceiver circuitry including transmitter and receiver banks, and the on-chiplet reconfigurable optical switch configured to selectively couple the optical transceiver circuitry to a subset of the OVL interfaces. The design further encodes the waveguide geometries, OVL coupler structures such as grating coupler array layouts or micro-lens array placements, switch chiplet layout, and other structural elements of the passive interposer system 300 described above.

A recipient of the device design 1302 (e.g., a photonic foundry, a semiconductor foundry, or an assembly house) uses the design file to fabricate the photonic chiplet system. The fabrication proceeds as follows:

Active interposer fabrication: For embodiments encoding the active silicon photonic interposer described above, the device design 1302 encodes layout data suitable for submission to a silicon photonic foundry. The fabrication platform is, in some embodiments, a silicon-on-insulator (SOI) photonic process. Fabrication steps include: patterning the waveguides on the SOI substrate using photolithography and dry etching; forming the doped phase-shifter regions in the MZI switch cell arms via ion implantation to create p-n or p-i-n junctions; depositing and patterning contact metallization to couple the driver circuits to the phase-shifter regions; and back-end-of-line integration including protective cladding deposition and via formation. In some embodiments the MMI couplers are fabricated using inverse-designed geometries produced via particle swarm optimization (PSO) combined with finite-difference time-domain (FDTD) simulation to achieve uniform 50/50 splitting across the C-band, with the PSO/FDTD-optimized dimensions encoded in the device design 1302. The chiplets are integrated onto the active interposer via flip-chip bonding or hybrid bonding, with optical coupling between the chiplets and the interposer achieved via edge coupling or grating coupling.

Where the interposer is a device design 1302 encodes a system in which the passive photonic interposer as described with reference to FIGS. 3, 7A, 7B, and 8A through 8D, the device design 1302 encodes layout data for the passive photonic interposer wafer and separately for the switch chiplet and the functional chiplets. The passive interposer is fabricated, in some embodiments, using a CMOS-compatible silicon nitride waveguide process, which does not require the active photonic components (phase shifters, modulators, photodetectors) that characterize the active interposer fabrication. The switch chiplet and the functional chiplets are fabricated separately—in some embodiments on different foundry platforms optimized for their respective functions—and are assembled onto the passive interposer via pick-and-place or direct bonding. The OVL interfaces are physically realized, in some embodiments, as grating coupler arrays on the interposer and corresponding grating coupler arrays or micro-lens arrays on the overlying chiplets, with vertical alignment features encoded in the device design 1302 to facilitate assembly.

The fabrication processes described above are non-limiting examples. A person of ordinary skill in the art, given the device design 1302 and the foregoing descriptions, can fabricate the photonic chiplet system using the described processes or equivalent alternatives.

A photonic chiplet system fabricated from the device design 1302 operates as described herein. The control circuitry programs the optical circuit switch to set a persistent connectivity configuration, establishing circuit-switched optical connections among the chiplets through the interposer waveguides. The chiplets exchange data optically through the persistent connections, and the control circuitry reprograms the switch as needed to match changing communication demands. Where the interposer is an active silicon photonic interposer, operation proceeds as described above with reference to FIG. 11. Where the interposer is a passive photonic interposer, operation proceeds as described above with reference to FIG. 12.

Although versions of the described technology have been described in considerable detail with reference to certain configurations, other configurations are possible. For example, the number of chiplets, the traffic patterns among chiplets, the switching network topology, the OVL coupler technology, the per-chiplet switch topology, the bandwidth allocation approach, and the implementation of the control circuitry may all differ from the specific embodiments described above. The described technology is not limited to the specific embodiments described above.

The embodiments and features described herein can be combined. For example, the precomputed switch configuration approach described above can be applied to implementations in which the interposer is an active silicon photonic interposer and to implementations in which the interposer is a passive photonic interposer. As another example, the loss-aware routing approach described above can be applied to an active interposer MZI switch fabric to minimize the use of cross-state cells. As another example, the broadcast and one-to-many routing approach described above can be implemented in the switch chiplet of implementations in which the interposer is a passive photonic interposer. All such combinations are contemplated.

Although certain embodiments have been illustrated as implementing specific combinations of features, the disclosure includes embodiments in which features described in different sections are practiced independently or in different combinations. The reader is directed to all papers and documents filed concurrently with this specification that are open to public inspection with this specification, and the contents of all such papers and documents are incorporated herein by reference.

Any element in a claim that does not explicitly state “means for” performing a specified function is not to be interpreted as a “means” clause as specified in 35 U.S.C. § 112(f). The previously described versions of the described technology have many advantages. It is not necessary that any particular version of the described technology exhibit all of the advantages described herein, and some versions may exhibit none of them.

The spirit and scope of the appended claims should not be limited to the description of the versions contained herein.

As used herein, the term “silicon photonics” conforms to its standard usage in the arts, and may include photonic systems and devices implemented on semiconductor-based platforms, including but not limited to group-IV semiconductors such as silicon and germanium, Group III-V compound semiconductors such as indium phosphide (InP) and gallium arsenide (GaAs), and other semiconductor materials or combinations thereof. In some embodiments, silicon photonics encompasses any integrated photonic technology that leverages semiconductor fabrication processes to realize optical components, regardless of the specific material composition, substrate structure, or integration scheme, including heterogeneous and hybrid integration approaches.

As used herein, the term “photonically coupled” refers to a structural relationship between two or more photonic elements in which the elements are arranged such that optical power is able to be transferred between the elements, directly or indirectly, including via coupling mechanisms or structures such as evanescent coupling or mode-coupled interaction regions, or via one or more optical paths (for example, a waveguide, coupler region, fiber, or free-space path), including arrangements in which coupling is mediated through one or more intermediate elements or materials. In contrast, the term “optically coupled” refers to an operational condition in which an optical signal is present and propagating such that optical power is in fact being transferred between the elements through the described coupling relationship. Unless otherwise specified, a pair of elements may be photonically coupled regardless of whether an optical signal is currently applied, and may be optically coupled when an optical signal is applied and propagates between the elements. As commonly occurs in the field, this usage may not be followed in all cases, and any inadvertent departures from this usage will be apparent from context.

As used herein, the term “microring resonator” refers to an optical resonator structure implemented in a silicon photonic platform and configured to confine and circulate light in a closed-loop path to achieve resonance at specific wavelengths. In some embodiments, a microring resonator may include, but is not limited to, a circular ring, an elliptical loop, a racetrack configuration, or other closed-loop geometries such as polygonal or hybrid shapes.

1. A system comprising:
an interposer comprising a plurality of waveguides;
a plurality of chiplets coupled to the interposer, each chiplet of the plurality of chiplets comprising a port coupled to a waveguide of the plurality of waveguides;
an optical circuit switch coupled to the plurality of waveguides and configured to selectively establish circuit-switched optical connections between chiplets of the plurality of chiplets via the plurality of waveguides; and
control circuitry coupled to the optical circuit switch and configured to program the optical circuit switch to set a connectivity configuration among the plurality of chiplets, the connectivity configuration persisting until reprogrammed by the control circuitry.

2. The system of claim 1, wherein the control circuitry is configured to:
maintain precomputed switch configurations for a plurality of connectivity patterns among the plurality of chiplets; and
retrieve and apply a precomputed switch configuration during operation in response to a circuit-configuration command.

3. The system of claim 1, wherein the optical circuit switch implements a switching network topology selected from the group consisting of a butterfly network topology, a crossbar network topology, a Clos network topology, a Benes network topology, and a PILOSS network topology.

4. The system of claim 1, wherein the interposer is an active interposer comprising a plurality of Mach-Zehnder interferometer switch cells, each Mach-Zehnder interferometer switch cell comprising:
a first optical coupler;
a second optical coupler; and
first and second waveguide arms extending between the first optical coupler and the second optical coupler,
each Mach-Zehnder interferometer switch cell configured to operate in a cross state, a bar state, or a divide state by application of a phase shift to at least one of the first and second waveguide arms,
wherein the optical circuit switch comprises the plurality of Mach-Zehnder interferometer switch cells.

5. The system of claim 4, wherein the plurality of chiplets comprises:
a memory chiplet; and
a plurality of multiply-accumulate chiplets,
wherein the optical circuit switch is configured to route optical signals between the memory chiplet and the plurality of multiply-accumulate chiplets via the plurality of waveguides.

6. The system of claim 4, wherein the control circuitry is configured to:
assign a chiplet of the plurality of chiplets to an input port of the optical circuit switch;
determine whether a requested circuit-switched optical connection would result in a blocking condition; and
in response, swap the input port assignment of a chiplet of the plurality of chiplets to a different input port of the optical circuit switch to resolve the blocking condition.

7. The system of claim 1, wherein the control circuitry is configured to:
operate a first set of 2×2 optical switching elements of the optical circuit switch in a cross state or a bar state to establish a one-to-one optical connection routing an optical signal from a source chiplet of the plurality of chiplets to a single destination chiplet of the plurality of chiplets; and
operate a second set 2×2 optical switching elements in a divide state to establish a one-to-many optical connection routing an optical signal from a source chiplet of the plurality of chiplets to each of a plurality of destination chiplets of the plurality of chiplets simultaneously.

8. The system of claim 1, wherein the optical circuit switch comprises a switch chiplet coupled to the interposer via optical vertical links, and wherein the waveguides of the interposer are passive waveguides coupling each chiplet of the plurality of chiplets to the switch chiplet.

9. The system of claim 8, wherein bandwidth allocation circuitry is configured to:
determine, for each of a plurality of pairs of chiplets, a respective traffic demand associated with that pair of chiplets;
iteratively allocate circuit-switched optical connections to pairs of chiplets in order of decreasing traffic demand, assigning additional circuit-switched optical connections to each pair until a connection threshold for that pair is satisfied; and
program the optical circuit switch to establish the allocated circuit-switched optical connections.

10. The system of claim 8, wherein a chiplet of the plurality of chiplets comprises:
a plurality of optical vertical link interfaces coupled to the interposer;
optical transceiver circuitry providing a plurality of active optical channels, the plurality of optical vertical link interfaces being greater in number than the plurality of active optical channels; and
a reconfigurable optical switch integrated within that chiplet and configured to operate as a cross-connect between the optical transceiver circuitry and the plurality of optical vertical link interfaces, the reconfigurable optical switch configured to selectively couple a subset of the plurality of optical vertical link interfaces to the optical transceiver circuitry.

11. The system of claim 10, wherein on-chiplet circuitry of that chiplet is configured to:
measure optical loss through each optical vertical link interface of the plurality of optical vertical link interfaces of that chiplet; and
configure the reconfigurable optical switch of that chiplet to couple a subset of the plurality of optical vertical link interfaces satisfying an optical loss condition to the optical transceiver circuitry of that chiplet.

12. The system of claim 10, wherein the reconfigurable optical switch of that chiplet is further configured to, in response to a control signal, expand the subset to include additional optical vertical link interfaces of the plurality of optical vertical link interfaces beyond those currently coupled to the optical transceiver circuitry.

13. A method comprising:
establishing, by an optical circuit switch coupled to a plurality of waveguides of an interposer to which a plurality of chiplets are coupled, a circuit-switched optical connection between a first chiplet and a second chiplet of the plurality of chiplets via the plurality of waveguides; and
programming, by control circuitry coupled to the optical circuit switch, the optical circuit switch to set a connectivity configuration among the plurality of chiplets, the connectivity configuration persisting until reprogrammed by the control circuitry.

14. The method of claim 13, further comprising:
storing precomputed switch configurations for a plurality of connectivity patterns among the plurality of chiplets; and
retrieving and applying, by the control circuitry, a precomputed switch configuration in response to a circuit-configuration command.

15. The method of claim 13, further comprising:
operating, by the control circuitry, a first set of Mach-Zehnder interferometer switch cells of an optical circuit switch comprised by an active interposer in a cross state or a bar state to establish a one-to-one optical connection routing an optical signal from a source chiplet of the plurality of chiplets to a single destination chiplet of the plurality of chiplets; and
operating, by the control circuitry, a second set of Mach-Zehnder interferometer switch cells of the optical circuit switch in a divide state to establish a one-to-many optical connection routing an optical signal from a source chiplet of the plurality of chiplets to each of a plurality of destination chiplets of the plurality of chiplets simultaneously.

16. The method of claim 13, further comprising:
determining, by bandwidth allocation circuitry, a respective traffic demand for each of a plurality of pairs of chiplets of the plurality of chiplets;
iteratively allocating, by the bandwidth allocation circuitry, circuit-switched optical connections to pairs of chiplets in order of decreasing traffic demand, assigning additional circuit-switched optical connections to each pair until a connection threshold for that pair is satisfied; and
programming the optical circuit switch to establish the allocated circuit-switched optical connections.

17. The method of claim 13, further comprising:
measuring, by on-chiplet circuitry of a chiplet of the plurality of chiplets, optical loss through each optical vertical link interface of a plurality of optical vertical link interfaces of that chiplet, the plurality of optical vertical link interfaces being greater in number than a plurality of active optical channels provided by optical transceiver circuitry of that chiplet; and
configuring, by the on-chiplet circuitry, a reconfigurable optical switch integrated within that chiplet to couple a subset of the plurality of optical vertical link interfaces satisfying an optical loss condition to the optical transceiver circuitry of that chiplet.

18. A non-transitory computer-readable medium storing a design for a photonic chiplet system, the design encoding:
an interposer comprising a plurality of waveguides;
a plurality of chiplets configured to be coupled to the interposer, each chiplet of the plurality of chiplets comprising a port configured to be coupled to a waveguide of the plurality of waveguides;
an optical circuit switch coupled to the plurality of waveguides and configured to selectively establish circuit-switched optical connections between chiplets of the plurality of chiplets via the plurality of waveguides; and
control circuitry coupled to the optical circuit switch and configured to program the optical circuit switch to set a connectivity configuration among the plurality of chiplets, the connectivity configuration persisting until reprogrammed by the control circuitry.

19. The non-transitory computer-readable medium of claim 18, wherein the design further encodes an active interposer comprising:
a plurality of Mach-Zehnder interferometer switch cells, each Mach-Zehnder interferometer switch cell comprising a first optical coupler, a second optical coupler, and first and second waveguide arms extending between the first optical coupler and the second optical coupler, each Mach-Zehnder interferometer switch cell configured to operate in a cross state, a bar state, or a divide state by application of a phase shift to at least one of the first and second waveguide arms,
wherein the optical circuit switch comprises the plurality of Mach-Zehnder interferometer switch cells.

20. The non-transitory computer-readable medium of claim 18, wherein the design further encodes:
a switch chiplet coupled to the interposer via optical vertical links, the switch chiplet comprising the optical circuit switch; and
passive waveguides forming the plurality of waveguides of the interposer and coupling each chiplet of the plurality of chiplets to the switch chiplet,
wherein a chiplet of the plurality of chiplets comprises a plurality of optical vertical link interfaces coupled to the interposer, optical transceiver circuitry providing a plurality of active optical channels, the plurality of optical vertical link interfaces being greater in number than the plurality of active optical channels, and a reconfigurable optical switch integrated within that chiplet and configured to operate as a cross-connect between the optical transceiver circuitry and the plurality of optical vertical link interfaces.
